(19) United States
(12) Patent Application Publication
(10) Pub. No.: US 2019/0052722 A1
(43) Pub. Date: Feb. 14, 2019

(54) DISTRIBUTED REPUTATIONAL DATABASE

(71) Applicant: Lincoln Gasking, Beaverton, OR (US)

(72) Inventor: Lincoln Gasking, Beaverton, OR (US)

(21) Appl. No.: 15/674,809

(22) Filed: Aug. 11, 2017

(51) Int. Cl. H04L 29/08; G06F 17/30

(52) U.S. Cl. CPC H04L 67/306; G06F 17/30867; G06F 17/30368; H04L 67/22

(57) ABSTRACT

A machine is configured to maintain a distributed reputational database of reputational records that each correspond to a different entity. Each reputational record may include a blockchain that accumulates reputationally relevant information for its corresponding entity. Each reputational record can be a reputational node within a reputational graph that maps interconnections among reputational records of various entities. Each reputational record may be correlated with an entity identifier permanently assigned to an entity and globally unique within the distributed reputational database. The distributed reputational database may implement a rule that a first entity cannot be added or have its reputational record change unless a second entity agrees to vouch for the first entity. Each entity may have a reputation score calculated based on its reputational record. The entity's reputation score may thus indicate the likelihood that the entity will be successful in future interaction events.

### TECHNICAL FIELD

The subject matter disclosed herein generally relates to the technical field of special-purpose machines that facilitate data management, including software-configured computerized variants of such special-purpose machines and improvements to such variants, and to the technologies by which such special-purpose machines become improved compared to other special-purpose machines that facilitate data management. Specifically, the present disclosure addresses systems and methods to facilitate provision and operation of a distributed reputational database.

### BACKGROUND

A machine may be configured to perform one or more data management operations, for example, by storing, maintaining, and updating one or more records within a database. The machine may be further configured to interact with one or more users by receiving one or more user requests for currently stored records, receiving one or more user requests to modify such records, processing such received requests, and generating and providing responses to such requests. In addition, the machine may be configured to automatically initiate generation and provision of one or more notifications (e.g., alerts or warnings regarding one or more records within the database).

### BRIEF DESCRIPTION OF THE DRAWINGS

Some embodiments are illustrated by way of example and not limitation in the figures of the accompanying drawings.

FIG. 1 is a network diagram illustrating a network environment suitable for a distributed reputational database, according to some example embodiments.

FIG. 2 is a block diagram illustrating components of a machine suitable for fully or partially managing a distributed reputational database, according to some example embodiments.

FIG. 3 is a block diagram illustrating components of a device suitable for fully or partially managing a distributed reputational database, according to some example embodiments.

FIG. 4 is a block diagram illustrating a reputational record stored by a distributed reputational database, according to some example embodiments.

FIG. 5 is a block diagram illustrating multiple reputational records within a distributed reputational database (e.g., a reputational graph of interconnected reputational nodes), according to some example embodiments.

FIGS. 6-12 are flowcharts illustrating operations in performing a method of updating a distributed reputational database, according to some example embodiments.

FIG. 13 is a block diagram illustrating components of a machine, according to some example embodiments, able to read instructions from a machine-readable medium and perform any one or more of the methodologies discussed herein.

### DETAILED DESCRIPTION

Example methods (e.g., algorithms) facilitate implementation, maintenance, and use of a distributed reputational database, and example systems (e.g., special-purpose machines configured by special-purpose software) are configured to facilitate such implementation, maintenance, and use of a distributed reputational database. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided. In the following description, for purposes of explanation, numerous specific details are set forth to provide a thorough understanding of various example embodiments. It will be evident to one skilled in the art, however, that the present subject matter may be practiced without these specific details.

A machine may be configured (e.g., by suitable software) to partially or fully generate, store, maintain (e.g., mediate or otherwise manage), and use a distributed database (e.g., based on blockchain technology) of reputational records that each correspond to a different entity (e.g., persons, organizations, objects, paths, processes, events, or locations). Each reputational record may be or include a blockchain or similar distributed data structure (e.g., a distributed ledger) that records and accumulates reputationally relevant information (e.g., participation data and feedback from various interaction events) for a corresponding entity, and each reputational record may therefore represent a reputational node within a reputational graph. Such a reputational graph may be analogous to a social graph, except encoding reputation information from interaction events instead of social information. Accordingly, the distributed database can be considered a distributed reputational database that includes interconnected reputational records, tracks relationships among reputational records, and thereby encodes a reputational graph of all entities represented within the distributed reputational database.

Moreover, each reputational record may be correlated with (e.g., by including, referencing, or being mapped to) an entity identifier that is permanently assigned to an entity and globally unique within the distributed reputational database. In example embodiments in which the machine disallows multiple reputational records for a single entity, the entity's reputational record can form a basis for a cross-domain (e.g., universally applicable throughout multiple network domains) repository of reputational information for that entity. In such a case, a cross-domain reputation score can be calculated for the entity by any server machine within any of several network domains (e.g., Twitter®, LinkedIn®, Tinder®, and Uber®). Such a reputation score may be a relative score (e.g., with respect to a neutral score or other reference score), a composite score (e.g., summarizing or otherwise representing an aggregate of multiple sub-scores), or both. Furthermore, in some example embodiments, calculation of a reputation score is influenced by reputation scores of other entities expected (e.g., scheduled) to interact with the entity whose reputation score is being calculated, such that, for example, the reputation score of a restaurant soon to be visited by a Michelin starred chef can be calculated differently than if the restaurant is slated to be visited by a new food critic for a local news organization.

In addition, in example embodiments where reputational records are implemented using blockchains or similar distributed data structures, the resulting distribution of each reputational record across multiple machines (e.g., devices) configured to achieve and maintain data integrity (e.g., via consensus algorithms) provides tamper resistance to the reputational records. This may have the effect of enhancing the trustworthiness of the distributed reputational database.

Furthermore, in some example embodiments, the distributed reputational database is configured to enforce a requirement that a new entity not previously represented in the reputational graph cannot be added unless an existing entity (e.g., with a reputation score at or above a predetermined threshold level) agrees to vouch for the new entity. Similarly, an existing entity represented in the reputational graph could be barred from altering their reputation score until such overarching agreement exists. Some example embodiments enforce a requirement that a vouching entity must be within a maximum distance (e.g., relative network geodesic distance) of the beneficiary entity being vouched for. Such configurations may have the effect of enhancing the accuracy or precision of the reputational information encoded within the reputational graph (e.g., by virtue of establishing and maintaining a sociologically closed network of entities).

The distributed reputational database can be configured to track reputational information (e.g., via the reputational records) for multiple kinds of entities as they interact in multiple contexts, from initial entry as a new entity represented in the reputational graph (e.g., at birth or at creation) and throughout their lifetimes (e.g., until death or destruction). Examples of such contexts include: agriculture, forestry, wildlife study, creative services (e.g., art), commerce, business, information management (e.g., search engines), communications (e.g., emails, phone calls, or text messages), construction, dating, education, entertainment (e.g., music), events, groups (e.g., family), child care, pet care, finance (e.g., currency exchange or stock exchange), hospitality (e.g., food service), sales (e.g., classified ads or auctions), gaming, health services (e.g., medical care or monitoring of biology and vital signs), security (e.g., identification or safety), insurance, Internet activities (e.g., social media, online forums, product reviews, or other online commentary), operation of Internet-of-things (IOT) devices, employment (e.g., jobs or skills), lending (e.g., student loans or consumer credit), navigation, vehicle maintenance, natural resource management (e.g., environmental studies), personal services, real estate (e.g., housing), social activities (e.g., attendance at events, participation in projects, or contributions to tasks), transportation (e.g., rideshare), and volunteerism (e.g., skills or dependability). In each of these example contexts, interaction events among multiple entities (e.g., actual or scheduled participants) and feedback therefrom (e.g., event participation data) may result in modifications to the reputational records that correspond to the participant entities.

Additional examples of such contexts include: administration, advertising, agencies, air travel, anti-spam, audits, autonomous vehicles, banking, bookings, bucket lists, achievements, building codes, capital flows, choosing patients and ranking operations, collaborations, classifieds, collections, commerce, commercial partners, commission, communication, communities, competitions, computing, construction, coupons, creativity, credit, cultural, data, dating, deals, debt, defense, deforestation, degrees, diagnoses, doctors, economics, education, emergency response, employers, energy, entertainers, escrow, events and groups, experts, family info, family, child care and pets, agriculture, financials, fishing, food, fraud, gaming, genealogy, geography, governing, history, hoaxes, homeschooling, hospitality, hospitals, hotels, identity, identity theft, insurance, inventory, investments, journalism, junk mail, justice, keys, legal docs, landlords, law, leasing, legal agreements, licensing, lifestyle, loans, location, major, marriage, meetings, media (e.g., photography and video), membership, microfinancing, motor vehicles, negotiations, networking, code change, parking, patients, payment, personal info and phone numbers, police, politics, private access, programming, renting, reports, research, responding on social media, restaurants, roads, robotics (e.g., robots and artificial intelligence (AI), safety, sales, schedules, science, search, security, sharing economy, skills, social activities, social security, social work, standards, statistics, students, study, subscription delivery, summation, system or method, taxation, teachers, theft, ticketing, tolls, traffic, translation, transportation and infrastructure, travel, trolling, venue codes, venues, vets, viruses, volunteers, warehouses, weddings, and zoning.

As inputs to the calculation of reputation scores, event participation data may take the form of one or more types of indicators. Such example indicators may quantify or otherwise indicate: nonlinear emotional results, safety (e.g., security, threats, or warnings), attendance bookings, hospitality, permissions (e.g., authorization), punctuality, requirements, governance, recording results, validity (e.g., being upheld), care, decisions (e.g., adjudications), management (e.g., maintenance), operations (e.g., activities), participation (e.g., experience), accuracy (e.g., presence of truth or facts), achievements (e.g., milestones), growth (e.g., in skill or other progress), quality control (e.g., inspections passed or failed), adherence to processes, itineraries, paths traversed (e.g., routes used), presence of harmony, arrangements, costs, revenues, profits, perceived value, buying, exchanges, sharing, compensation, equality, ethics (e.g., presence of corruption), utility, sources (e.g., origins), originality, wealth, energy, legitimacy, identity (e.g., known or unknown), intentions, abilities, skills, purity, fidelity, rank, privacy, quality, level of access, services, promises kept, promises broken, level of protection, scores, grades, ownership, possession, predictions, provenance, ratings of third parties, resource quality, memberships, authenticity, status, inclusion, constituents, functions, roles, subdivisions (e.g., portions or sections), contributions, components, genuineness, credibility, relative position, conditions, boundaries, limits, assessments, appraisals, level of quality, level of ability, extent, significance, parts, prizes, level of respect, measurements, feedback, ingredients, substances, properties, materials, parties involved, or any suitable combination thereof.

Accordingly, each entity may have a corresponding reputation score that is calculated based on the corresponding reputational record maintained by the distributed reputational database. The entity's reputation score can thus be used as an indicator or predictor of the likelihood that the entity will be successful in future interaction events (e.g., provide a positive contribution or increase the likelihood of a positive experience for other entities). In some example embodiments, the entity's reputation score may indicate or predict the likelihood that the entity will be unsuccessful in future interaction events (e.g., provide a negative contribution or increase the likelihood of a negative experience for other entities).

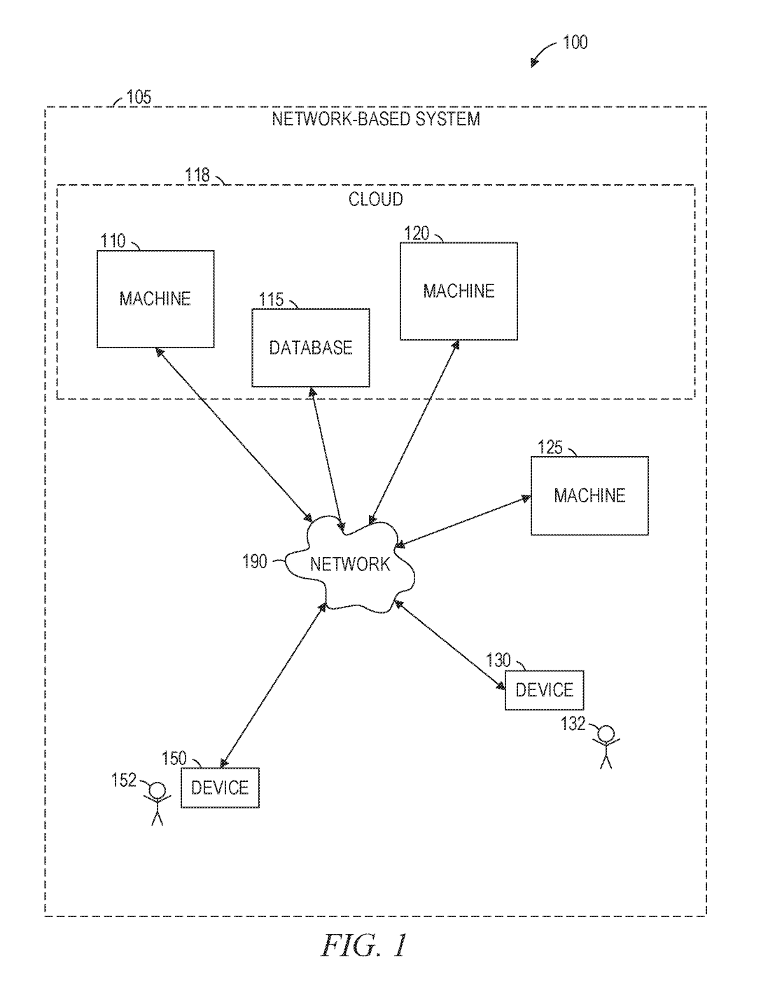

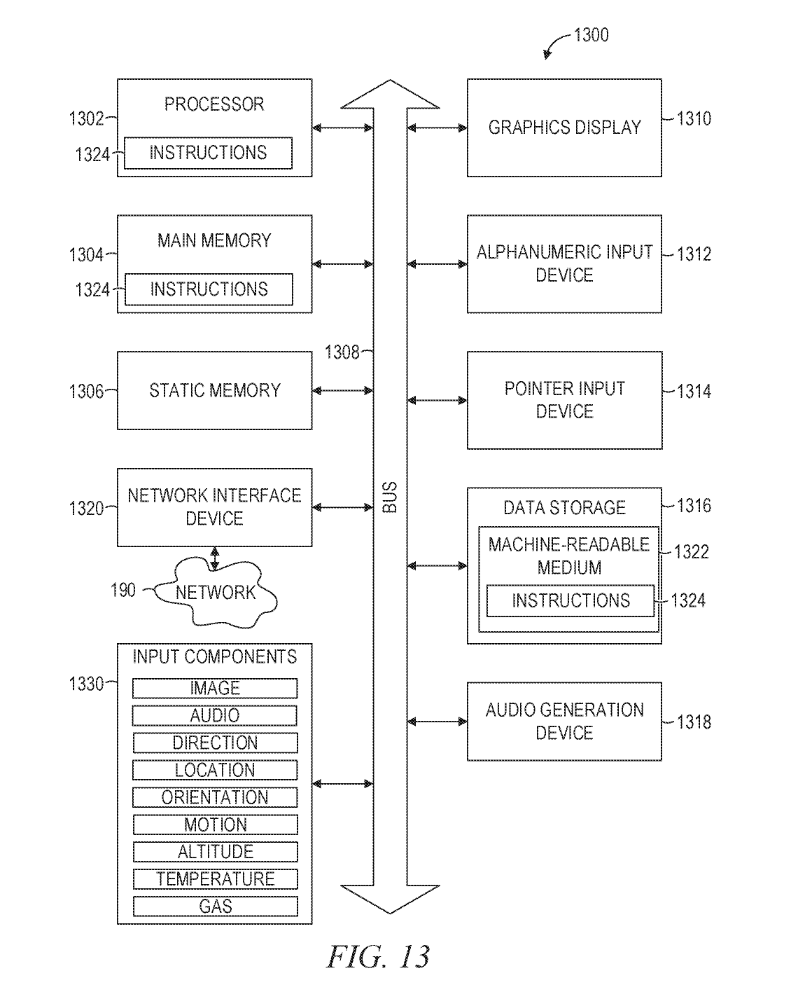

FIG. 1 is a network diagram illustrating a network environment 100 suitable for implementing a distributed reputational database, according to some example embodiments. The network environment 100 includes machines 110, 120, and 125 (e.g., server machines, in the same network domain or spread across multiple network domains), a database 115 (e.g., a relational database), and devices 130 and 150, all communicatively coupled to each other via a network 190. The machines 110 and 120, with or without the database 115, may form all or part of a cloud 118 (e.g., a geographically distributed set of multiple machines configured to function as a single server), while the machine 125 may be outside the cloud 118. As shown in FIG. 1, any one or more of the machines 110, 120, and 125, the database 115, or the devices 130 and 150 may form all or part of a network-based system 105 (e.g., a cloud-based server system configured to provide one or more network-based services to various machines, such as or similar to the devices 130 and 150). The machines 110, 120, and 125, the database 115, and the devices 130 and 150 may each be implemented in a special-purpose (e.g., specialized) computer system, in whole or in part, as described below with respect to FIG. 13. Accordingly, any one or more example embodiments of the distributed reputational database described herein can be distributed across any one or more of the machines (e.g., machine 110), databases (e.g., database 115), or devices (e.g., device 130) within the network-based system 105.

Furthermore, any one or more of the machines, databases, or devices in the network-based system 105 may be prioritized using a marketplace, with decisions regarding usage and resources they automatically determined according to the reputation scores of individual machines, databases, and devices. This may have the effect of limiting or improving the rate at which one or more of the methodologies discussed herein are performed. In some cases, this may enhance the commercial value of the more reputable machines, databases, and devices.

Also shown in FIG. 1 are users 132 and 152. One or both of the users 132 and 152 may be a human user (e.g., a human being), a machine user (e.g., a computer configured by a software program to interact with the device 130 or 150), or any suitable combination thereof (e.g., a human assisted by a machine or a machine supervised by a human). The user 132 is associated with the device 130 and may be a user of the device 130. For example, the device 130 may be a desktop computer, a vehicle computer, a tablet computer, a navigational device, a portable media device, a smart phone, or a wearable device (e.g., a smart watch, smart glasses, smart clothing, or smart jewelry) belonging to the user 132. Likewise, the user 152 is associated with the device 150 and may be a user of the device 150. As an example, the device 150 may be a desktop computer, a vehicle computer, a tablet computer, a navigational device, a portable media device, a smart phone, or a wearable device (e.g., a smart watch, smart glasses, smart clothing, or smart jewelry) belonging to the user 152.

Any of the systems or machines (e.g., databases and devices) shown in FIG. 1 may be, include, or otherwise be implemented in a special-purpose (e.g., specialized or otherwise non-conventional and non-generic) computer that has been modified to perform one or more of the functions described herein for that system or machine (e.g., configured or programmed by special-purpose software, such as one or more software modules of a special-purpose application, operating system, firmware, middleware, or other software program). For example, a special-purpose computer system able to implement any one or more of the methodologies described herein is discussed below with respect to FIG. 13, and such a special-purpose computer may accordingly be a means for performing any one or more of the methodologies discussed herein. Within the technical field of such special-purpose computers, a special-purpose computer that has been specially modified (e.g., configured by special-purpose software) by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines.

As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the systems or machines illustrated in FIG. 1 may be combined into a single system or machine, and the functions described herein for any single system or machine may be subdivided among multiple systems or machines.

The network 190 may be any network that enables communication between or among systems, machines, databases, and devices (e.g., between the machine 110 and the device 130). Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof. Accordingly, the network 190 may include one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., a WiFi network or WiMax network), or any suitable combination thereof. Any one or more portions of the network 190 may communicate information via a transmission medium. As used herein, “transmission medium” refers to any intangible (e.g., transitory) medium that is capable of communicating (e.g., transmitting) instructions for execution by a machine (e.g., by one or more processors of such a machine), and includes digital or analog communication signals or other intangible media to facilitate communication of such software.

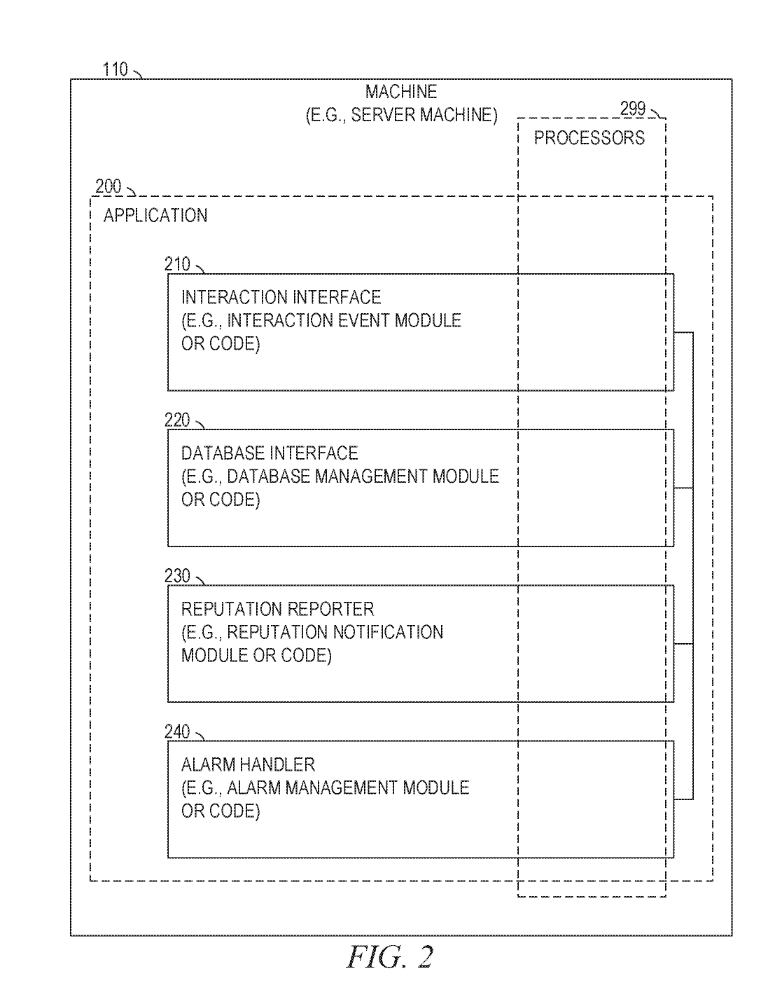

FIG. 2 is a block diagram illustrating components of the machine 110, which is suitable for fully or partially managing a distributed reputational database (e.g., in consensus with one or more other machines, such as the machine 120 or the device 130), according to some example embodiments. The machine 110 is shown as including an interaction interface 210, a database interface 220, a reputation reporter 230, and alarm handler 240, all configured to communicate with each other (e.g., via a bus, shared memory, or a switch). The interaction interface 210 may be or include an interaction event module or similarly suitable software code for receiving information regarding one or more interaction events among entities, processing such information, and responding to such information. The database interface 220 may be or include a database management module or similarly suitable software code for interacting with the distributed reputational database (e.g., managing, updating, or verifying one or more reputational records in the form of one or more reputational blockchains that correspond to entities). The reputation reporter 230 may be or include a reputation notification module or similarly suitable software code for calculating one or more reputation scores of corresponding entities and managing communications based on such reputation scores (e.g., responding to queries or providing notifications). The alarm handler 240 may be or include an alarm management module or similarly suitable software code for managing one or more alarms raised by corresponding entities (e.g., requesting verification or investigation by entities whose devices are geographically within a predetermined threshold distance of a device of the alarm-raising entity).

As shown in FIG. 2, the interaction interface 210, the database interface 220, the reputation reporter 230, and the alarm handler 240 may form all or part of an application 200 (e.g., a server application, a client application, or a mobile app) that is stored (e.g., installed) on the machine 110 (e.g., responsive to, or otherwise as a result of, data being received via the network 190). Furthermore, one or more processors 299 (e.g., hardware processors, digital processors, or any suitable combination thereof) may be included (e.g., temporarily or permanently) in the application 200, the interaction interface 210, the database interface 220, the reputation reporter 230, the alarm handler 240, or any suitable combination thereof.

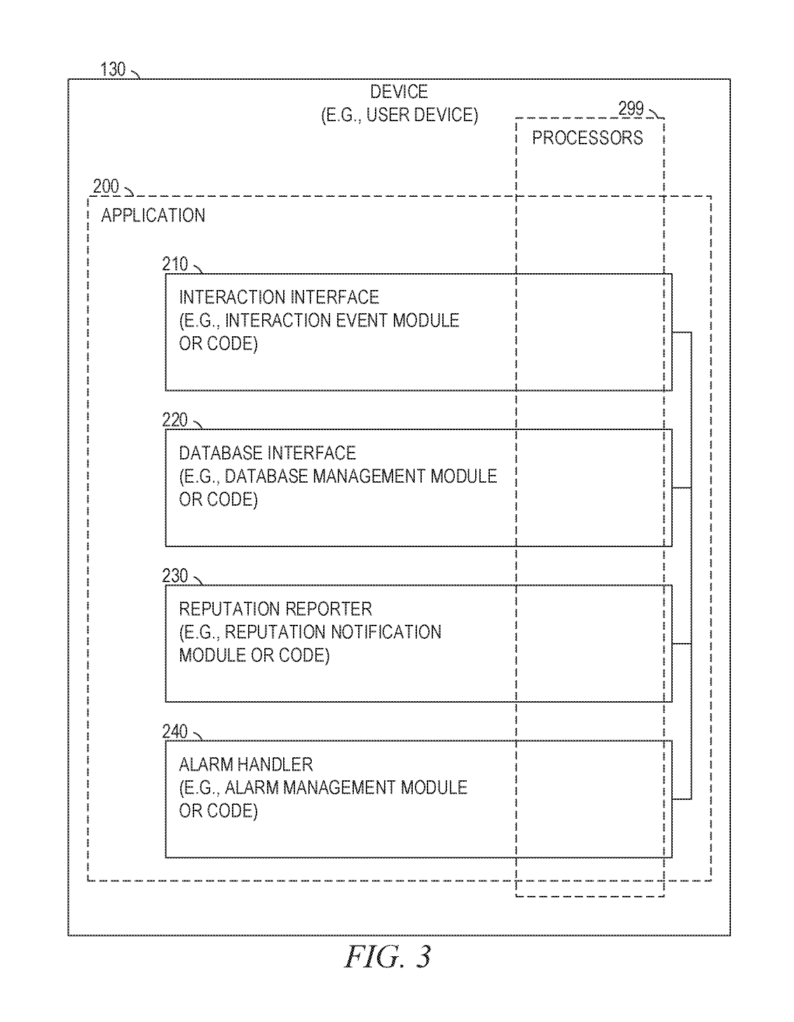

FIG. 3 is a block diagram illustrating components of the device 130, which is suitable for fully or partially managing a distributed reputational database (e.g., in consensus with one or more other machines, such as the machines 110 and 120), according to some example embodiments. The device 130 is shown as including the interaction interface 210, the database interface 220, the reputation reporter 230, and the alarm handler 240, all configured to communicate with each other (e.g., via a bus, shared memory, or a switch). Furthermore, as shown in FIG. 3, the application 200 may be stored (e.g., installed) on the device 130 (e.g., responsive to, or otherwise as a result of, data being received via the network 190). In addition, one or more processors 299 (e.g., hardware processors, digital processors, or any suitable combination thereof) may be included (e.g., temporarily or permanently) in the application 200, the interaction interface 210, the database interface 220, the reputation reporter 230, the alarm handler 240, or any suitable combination thereof.

Any one or more of the components (e.g., modules) described herein may be implemented using hardware alone (e.g., one or more of the processors 299) or a combination of hardware and software. For example, any component described herein may physically include an arrangement of one or more of the processors 299 (e.g., a subset of or among the processors 299) configured to perform the operations described herein for that component. As another example, any component described herein may include software, hardware, or both, that configure an arrangement of one or more of the processors 299 to perform the operations described herein for that component. Accordingly, different components described herein may include and configure different arrangements of the processors 299 at different points in time or a single arrangement of the processors 299 at different points in time. Each component (e.g., module) described herein is an example of a means for performing the operations described herein for that component. Moreover, any two or more components described herein may be combined into a single component, and the functions described herein for a single component may be subdivided among multiple components. Furthermore, according to various example embodiments, components described herein as being implemented within a single system or machine (e.g., a single device) may be distributed across multiple systems or machines (e.g., multiple devices).

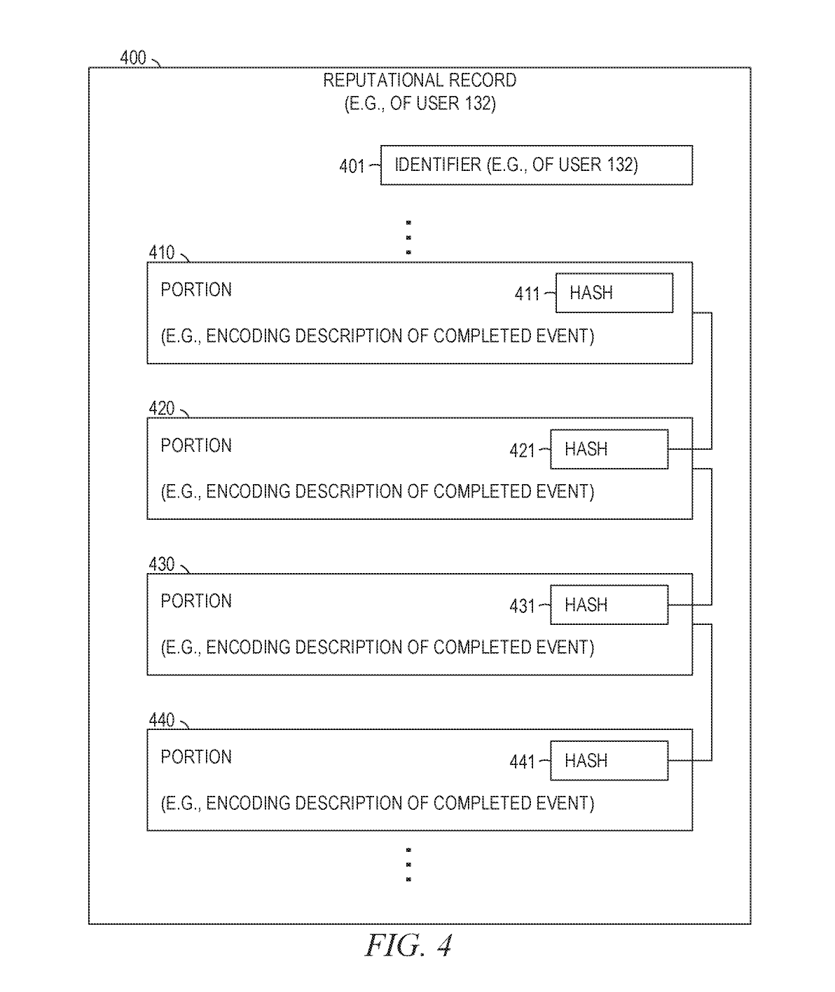

FIG. 4 is a block diagram illustrating a reputational record 400 stored within a distributed reputational database, according to some example embodiments. As noted above, the reputational record 400 itself may be distributed across multiple machines. As shown in FIG. 4, the reputational record 400 corresponds to an entity (e.g., user 132, a company, a team, a product, a food, or a venue), and the reputational record 400 stores (e.g., by encoding or other representation) reputationally relevant information about its corresponding entity. For example, such reputationally relevant information may be or include a history of completed interaction events in which participation by the corresponding entity had been expected (e.g., scheduled or otherwise indicated as expected to occur). In some example embodiments, the completed interaction events include events that occurred spontaneously (e.g., without prior scheduling or indicated expectation).

As shown in FIG. 4, the reputational record 400 may include an identifier 401 that identifies the entity (e.g., user 132) to whom or which the reputational record 400 corresponds. The identifier 401 may be a globally unique identifier for that entity within the distributed reputational database (e.g., in accordance with a rule that disallows non-unique identifiers for a given entity). In some example embodiments, the identifier 401 is stored within the reputational record 400, while in alternative example embodiments, the reputational record 400 stores a reference (e.g., link, address, or pointer) to the actual identifier 401.

As noted above, the reputational record 400 may be implemented using a blockchain or a functionally similar distributed data structure. As shown in FIG. 4, the reputational record 400 may accordingly include multiple portions 410, 420, 430, and 440. Such portions may be considered as blocks of data within the data structure that forms the reputational record 400. Each of the portions 410, 420, 430, and 440 may encode or otherwise represent a corresponding description of a corresponding completed interaction event. Examples of interaction events include: a meeting (e.g., online or in person) attended by entities that include people, machines, a location (e.g., a venue, such as a meeting room), or any suitable combination thereof; performance of a service (e.g., temporal path in performing a task) by entities that include people, objects (e.g., tools), machines, organizations, a location (e.g., a venue), or any suitable combination thereof; assembly of a product by entities that include people, objects (e.g., components), machines, organizations, a location (e.g., a venue, such as a factory), or any suitable combination thereof; and preparation of a food (e.g., an entree dish or a dessert dish) by entities that include people (e.g., chefs), components (e.g., ingredients), machines, organizations, a location (e.g., a restaurant), or any suitable combination thereof. As one example, in the context of security, an interaction event can be or include the entering of the building, the accessing of sensitive data (e.g., a file, an email, a phone call), the accessing of the sensitive object (e.g., a computer or other machine), or any suitable combination thereof.

As additionally shown in FIG. 4, hashes 411, 421, 431, and 441 (e.g., values obtained by hashing) may be respectively included in the portions 410, 420, 430, and 440. Each hash (e.g., hash 421) within a portion (e.g., portion 420) is derived from the preceding portion (e.g., 410). For example, the hash 411 in the portion 410 may have been generated by hashing some or all of the portion that preceded the portion 410 in the reputational record 400; the hash 421 in the portion 420 may have been generated by hashing some or all of the portion 410; the hash 431 in the portion 430 may have been generated by hashing some or all of the portion 420; and the hash 441 in the portion 440 may have been generated by hashing some or all of the portion 430.

When a new portion (e.g., portion 440) is added to the reputational record 400, the reputational record 400 is extended by the addition of the new portion (e.g., by one more block of data, representing one more completed interaction event). Thus, when the reputational record 400 is updated to accommodate additional information about a completed interaction event that involves the corresponding entity, the reputational record 400 is modified by extending the reputational record 400 to include the additional information in a new portion (e.g., portion 440) of the reputational record 400.

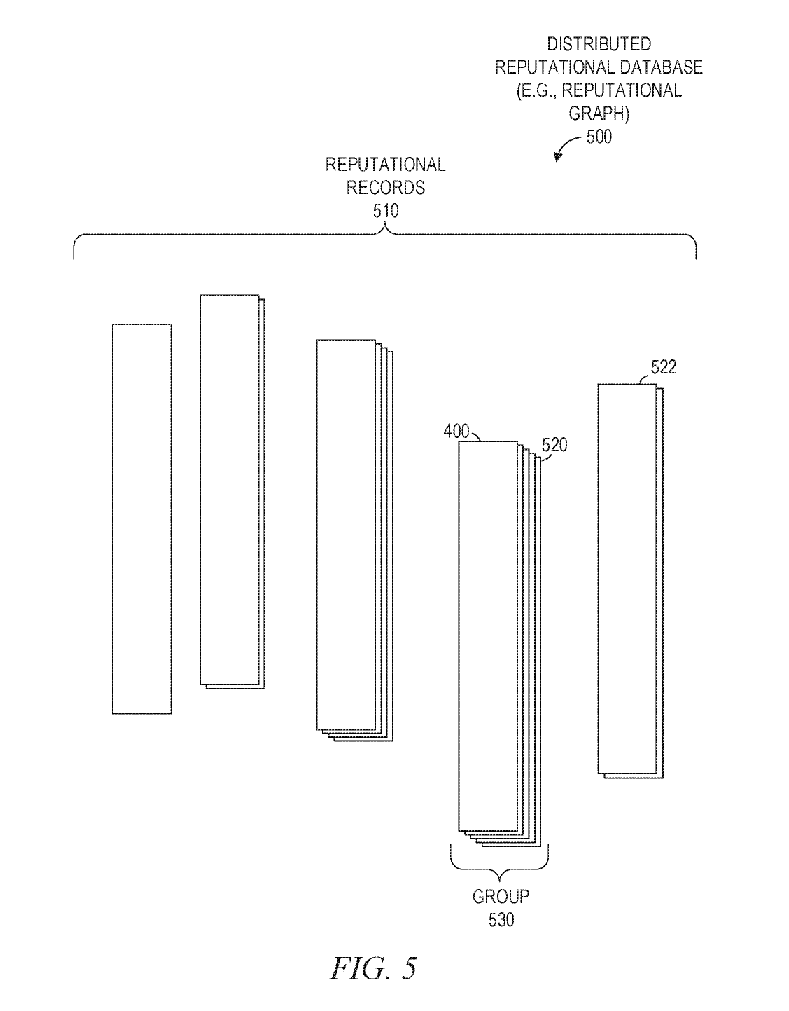

FIG. 5 is a block diagram illustrating multiple reputational records 510 within a distributed reputational database 500, according to some example embodiments. As noted above, the distributed reputational database 500 may be or include a reputational graph of interconnected reputational nodes that are each represented by a different reputational record (e.g., reputational record 400). Individual reputational records 400, 520, and 522 are shown in FIG. 5 as being included within the reputational records 510. Furthermore, the reputational record 400 may be a first reputational record that corresponds to a first entity (e.g., user 132), and the reputational record 520 may be a second reputational record that corresponds to a second entity (e.g., user 152). In such a situation, these reputational records 400 and 520 (e.g., with one or more additional reputational records) may form all or part of a group 530 of reputational records. For a given interaction event (e.g., a meeting in which the user 132 and the user 152 both participate), the group 530 of reputational records may contain all reputational records (e.g., including reputational records 400 and 520) of all participant entities (e.g., including the users 132 and 152). For example, the group 530 of reputational records may correspond to a group of entities whose participation in the interaction event had been previously scheduled. As another example, the group 530 of reputational records may correspond to a group of entities who actually participated in the interaction event.

In addition, FIG. 5 illustrates the reputational record 522 being included in the reputational records 510 but remaining separate from the group 530 of reputational records. In some example embodiments, a completed interaction event (e.g., a recurring meeting or an annual festival) has a reputational record of its own (e.g., reputational record 522) for encoding its corresponding history of reputationally relevant information. In certain example embodiments, an outcome (e.g., a product or other result) of a completed interaction event (e.g., a product assembled at a factory or a sack of flour produced at a wheat mill) has its own reputational record (e.g., reputational record 522) for encoding its corresponding subsequent history of additional interaction events.

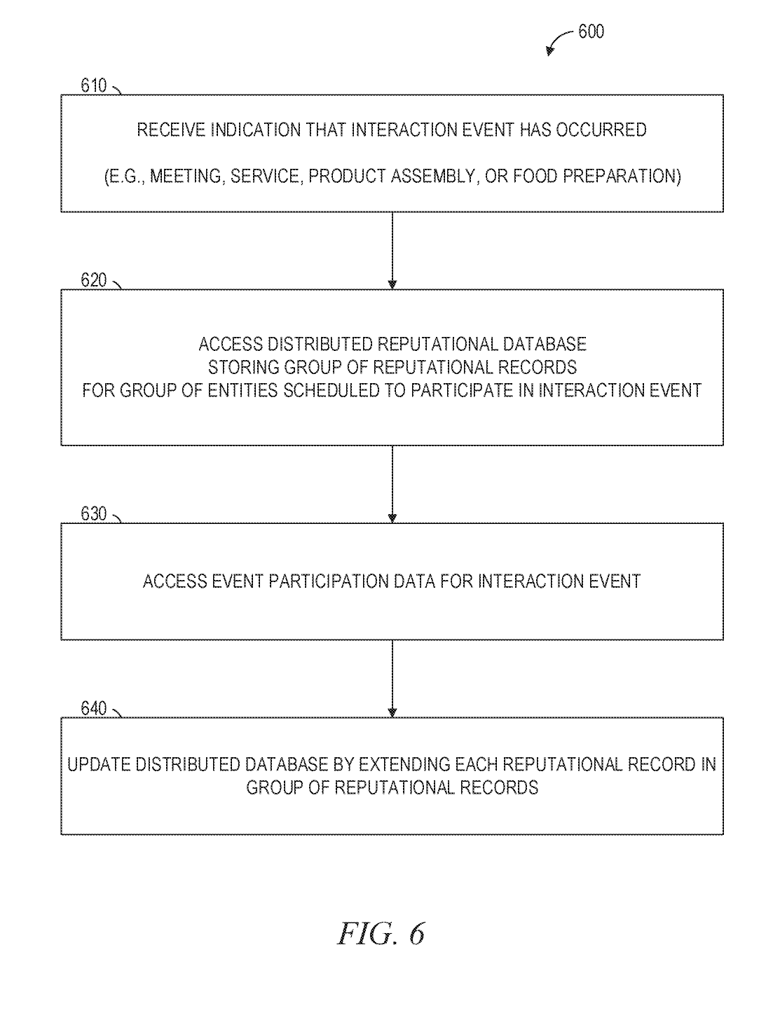

FIGS. 6-12 are flowcharts illustrating operations in performing a method 600 of updating the distributed reputational database 500, according to some example embodiments. Operations in the method 600 may be performed individually or collectively by any one or more of the machines 110, 120, and 125, the database 115, and the devices 130 and 150, using components (e.g., modules) described above with respect to FIGS. 2 and 3, using one or more processors (e.g., microprocessors or other hardware processors), or using any suitable combination thereof. As shown in FIG. 6, the method 600 includes operations 610, 620, 630, and 640.

In operation 610, the interaction interface 210 receives an indication that an interaction event with scheduled participation by a group of entities (e.g., represented by the group 530 of reputational records) has occurred. This indication may be received by accessing calendar data (e.g., from the database 115 or one or more of the devices 130 or 150) that indicates which entities were scheduled to participate in the interaction event. According to various example use cases, the interaction event can be or include a meeting, performance of a service, assembly of a product, preparation of food, or any suitable combination thereof. As noted above, various additional use cases in various additional contacts are contemplated for occurrences of interaction events in which multiple entities interact with each other.

In operation 620, the database interface 220 accesses the distributed reputational database 500, which may be collectively implemented across any one or more machines (e.g., machine 110), databases (e.g., database 115), or devices (e.g., device 130) in the network-based system 105. As noted above, the distributed reputational database 500 stores the reputational records 510, and each reputational record (e.g., reputational record 400) may encode a different history of completed events in which participation by a corresponding different entity (e.g., user 132) had been scheduled. In particular, the distributed reputational database 500 stores the group 530 of reputational records that collectively correspond to the entities that were scheduled to participate in the interaction event indicated to have occurred, and each reputational record (e.g., reputational record 520) in the group 530 corresponds to a different entity among the entities that were scheduled to participate in the interaction event.

In operation 630, the database interface 220 accesses event participation data that describes the actual participation by the scheduled entities in the interaction event that was indicated to have occurred. The event participation data may be accessed by receiving one or more portions of the event participation data from devices (e.g., devices 130 and 150) that respectively correspond to one or more of the entities (e.g., users 132 and 152) that actually participated in the interaction event, which may form a subset, superset, or different set of entities compared to the entities that were scheduled to participate in the interaction event. In some example embodiments, one or more machines (e.g., machine 110), databases (e.g., database 115), or devices (e.g., device 130) in the network-based system 105 are configured to function as an intermediate or ultimate collection point for the event participation data, and the database interface 220 may accordingly access the event participation data therefrom.

In some example embodiments, one or more devices (e.g., device 150) provide corresponding portions of the event participation data in accordance with execution of a background process that operates when the one or more devices are in a dormant, idle, sleeping, or otherwise passive state. That is, a device need not necessarily be actively executing any portion of the method 600 in order to provide some event participation data regarding its corresponding entity (e.g., user 152).

In operation 640, the database interface 220 updates the distributed reputational database 500 by extending each reputational record (e.g., reputational record 520) in the group 530 of reputational records that collectively correspond to the entities that were scheduled to participate in the interaction event. As noted above, in accordance with various example embodiments, each one of these reputational records in the group 530 encodes a different history of completed events in which participation by a corresponding different entity had been scheduled. Moreover, the extending of each reputational record (e.g., reputational record 520) may be based on some portion or all of the event participation data access in operation 630. Furthermore, the extending of each reputational record (e.g., reputational record 520) may be in response to the receiving of the indication in operation 610.

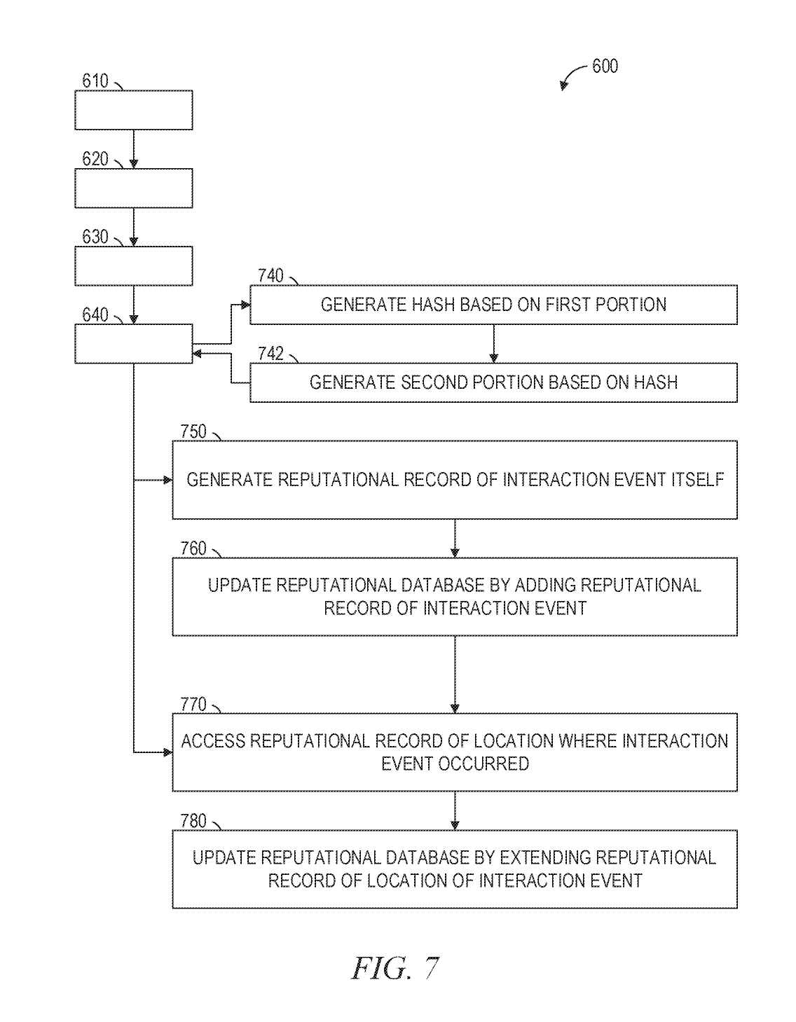

As shown in FIG. 7, in addition to any one or more of the operations previously described, the method 600 may include one or more of operations 740, 742, 750, 760, 770, and 780. One or both of operations 740 and 742 may be performed as part (e.g., a precursor task, a subroutine, or a portion) of operation 640, in which the database interface 220 updates the distributed reputational database 500 by extending each of the reputational records (e.g., reputational record 400) in the group 530 of reputational records. For example, the combination of operations 740 and 742 may be performed for each of the reputational records (e.g., reputational record 400) being processed in operation 640.

In operation 740, the database interface 220 generates a hash (e.g., hash 441) based on a first portion (e.g., portion 430) ofa reputational record (e.g., reputational record 400) being processed. According to various example embodiments, the generated hash identifies the first portion of the reputational record and encodes a description of a completed event that is most recently present to the interaction event indicated as having occurred. In some example embodiments, generation of a hash (e.g., hash 441) includes a proof-of-work scheme that provides resources (e.g., input data) to the database interface 220 in exchange for performance of a specified task (e.g., participating in a training set for a convolution neural network for a specified time or a specified number of computations).

In certain example embodiments, such generation of a hash (e.g., hash 441) is incentivized by a rule (e.g., implemented throughout the network-based system 105 by each instance of the application 200) by which the database interface 220 performs the generation of the hash in exchange for (e.g., in response to) receipt or other detection of a payment. Such a payment may take the example form of a cryptographic token or an amount of cryptographic currency, and the distributed reputational database 500 may store and update payment records in a manner similar to that described herein for reputational records (e.g., reputational record 400). Thus, operation 740 may be performed in response to the detection that such a payment has been, or will be, provided to the entity that corresponds (e.g., by virtue of ownership, possession, control, or authorization) to the machine (e.g., machine 110), database (e.g., database 115), or device (e.g., device 130) whose instance of the database interface 220 is performing operation 740. For example, in the case of multiple instances of the application 200 within the network-based system 105, the entity (e.g., user 132 of the device 130) whose instance of the database interface 220 is performing operation 740 would receive the payment.

In operation 742, the database interface 220 generates a second portion (e.g., portion 440) of the reputational record (e.g., reputational record 400) being processed. According to various example embodiments, the generated second portion becomes a newly added portion of the corresponding event history encoded by the reputational record. In performing operation 742, the database interface 220 may add the generated second portion to the reputational record, and the newly added second portion may include a description of the interaction event that was indicated as having occurred. Furthermore, the generated second portion includes the hash (e.g., hash 441) that was generated in operation 740.

As shown in FIG. 7, one or both of operations 750 and 760 may be performed subsequent to operation 640, in which the database interface 220 updates the distributed reputational database 500. In operation 750, the database interface 220 generates a new reputational record (e.g., reputational record 522 or similar) that corresponds to the interaction event itself. The generation of this new reputational record may be based on at least a subset of the reputational records (e.g., group 530 of reputational records) that were extended in operation 640, where the subset corresponds to only those entities whose actual participation in the interaction event is described by the event participation data accessed in operation 630. That is, the new reputational record of the interaction itself may be generated based on each one of the reputational records corresponding to entities that actually participated in the interaction event (in contrast with all entities scheduled to participate in the interaction event), plus one or more additional reputational records for entities that actually participated but were not scheduled to do so.

In operation 760, the database interface 220 updates the distributed reputational database 500 by adding the reputational record (e.g., reputational record 522 or similar) freshly generated in operation 750 to the distributed reputational database 500. Accordingly, the reputational records 510 stored by the distributed reputational database 500 may be increased by the addition of the newly generated reputational record for the interaction event itself.

As shown in FIG. 7, one or both of operations 770 and 780 may be performed subsequent to operation 640, in which the database interface 220 updates the distributed reputational database 500. In operation 770, the database interface 220 accesses a reputational record (e.g., reputational record 522 or similar) that corresponds to a location of the interaction event that was indicated to have occurred (e.g., a venue, a building, an address, a neighborhood, or a city). This reputational record for the location may be stored among the reputational records 510 within the distributed reputational database 500 and accessed therefrom. According to various example embodiments, the reputational record of a location may be indicative of one or more qualities present at that location (e.g., safety, popularity, traffic, repair condition, beauty, or any suitable combination thereof). Accordingly, some example embodiments may be configured to provide a user (e.g., user 132) with a series of recommendations for traversing a sequence of high reputation locations. In a similar manner, performable processes (e.g., recipes or assembly instructions) may each have their own reputational record, and some example embodiments may be configured to provide a user (e.g., user 132) with a series of recommendations for performing a sequence of high reputation processes.

In operation 780, the database interface 220 updates the distributed reputational database 500 by extending the reputational record (e.g., reputational record 522 or similar) accessed in operation 770. Extension of this reputational record (e.g., in a manner similar to that discussed above with respect to FIG. 4) may be based on some portion or all of the event participation data accessed in operation 630. In example embodiments in which a reputation score of the location is calculated based on the reputational record of the location, a prior performance of operation 780 may have caused the reputation score of the location to be updated in accordance with the event participation data for the interaction event that occurred at the location.

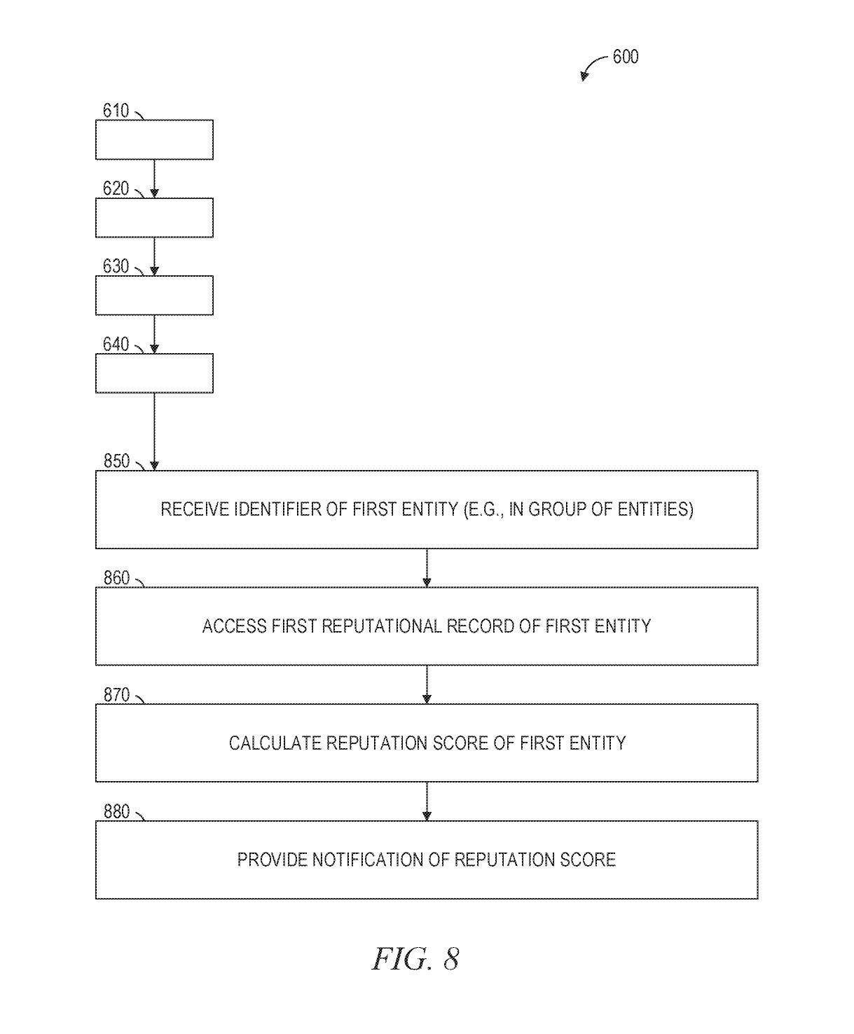

As shown in FIG. 8, in addition to any one or more of the operations previously described, the method 600 may include one or more of operations 850, 860, 870, and 880. Any one or more of operations 850, 860, 870, and 880 may be performed at any point in the method 600, though for clarity of illustration, FIG. 8 depicts these operations being performed after operation 640, in which the database interface 220 updates the distributed reputational database 500.

In operation 850, the reputation reporter 230 receives an entity identifier that identifies a first entity (e.g., user 132). The entity identifier may be received from a device of a second entity (e.g., device 150 of user 152). For example, the user 152 may cause her device 150 to communicate a request for notification of a reputation score that describes and corresponds to the first entity (e.g., user 132), and such a request may include the entity identifier of first entity, such that this entity identifier is received by the reputation reporter 230 in operation 850.

In some example embodiments, the first entity is included among the entities that actually participated in the interaction event and whose reputational records (e.g., group 530 of reputational records) were each extended in the updating of the distributed reputational database 500 in operation 640. In alternative example embodiments, the first entity is included among the entities that were scheduled to participate in the interaction event but did not actually participate therein. In further alternative example embodiments, the first entity has a reputational record (e.g., reputational record 522 or similar) in the distributed reputational database 500 but was not scheduled to participate in the interaction event and did not participate therein.

In operation 860, the reputation reporter 230 accesses a first reputational record (e.g., reputational record 522 or similar) that corresponds to the first entity (e.g., user 132) identified by the entity identifier received in operation 850. This reputational record may be accessed from the distributed reputational database 500, including from a relevant portion thereof (e.g., group 530 of reputational records). In example embodiments where the first reputational record is among the reputational records that were extended in operation 640, the reputation reporter 230 accesses the first reputational record in its extended state (e.g., extended in a manner similar to that discussed above with respect to FIG. 4).

In operation 870, the reputation reporter 230 calculates the reputation score of the first entity (e.g., user 132). The calculation of the reputation score may be based on the first reputational record of the first entity, as accessed in operation 860. When calculated, the reputation score of the first entity quantifies the likelihood that the first entity will successfully participate in future interaction events with other entities. Accordingly, the calculated reputation score of the first entity can be used as a predictor of potential for future success in such future interaction events with other entities.

In operation 880, the reputation reporter 230 provides a notification of the reputation score for the first entity (e.g., user 132), as calculated in operation 870. This notification may be provided to a device of another entity (e.g., device 150 of the user 152). Furthermore, this notification may be provided in response to operation 850, in which the reputation reporter 230 receives the entity identifier that identifies the first entity. For example, the notification may be provided by the reputation reporter 230 to the device 150 of the user 152 in response to a previously communicated request, received from the same device 150, for notification of the reputation score that describes and corresponds to the first entity.

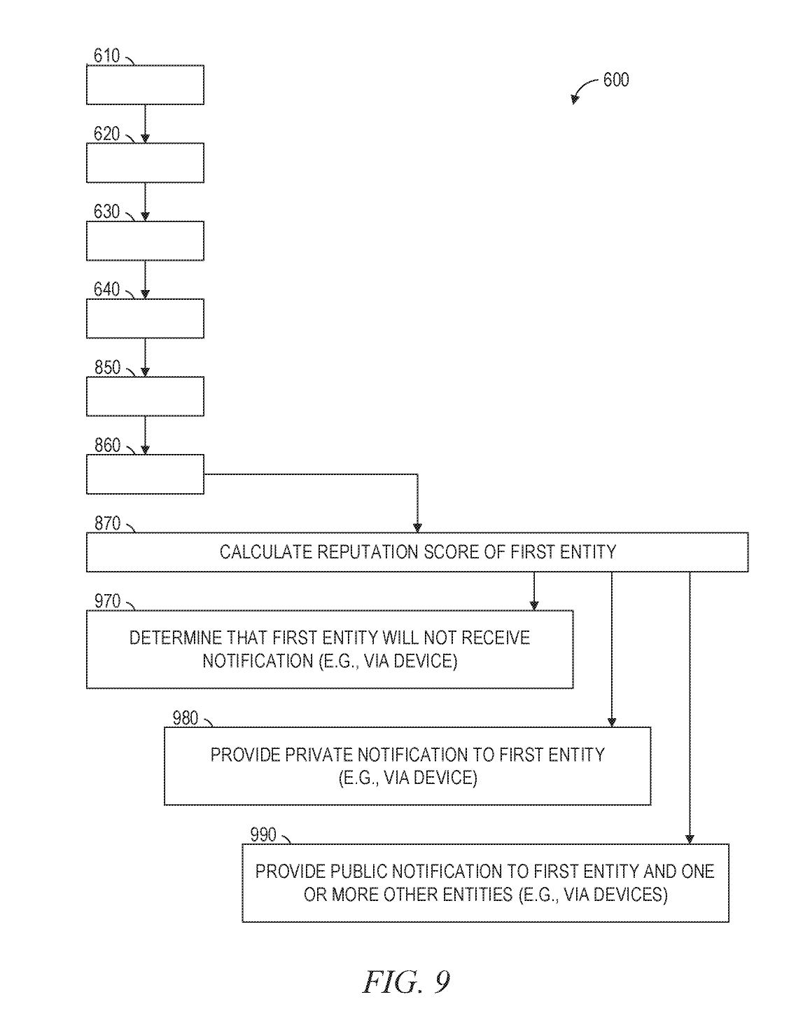

As shown in FIG. 9, in addition to any one or more of the operations previously described, the method 600 may include one or more of operations 970, 980, and 990. Any one or more of operations 970, 980, and 990 may be performed after operation 870 in which the reputation reporter 230 calculates the reputation score of the first entity (e.g., user 132).

According to some example embodiments, the reputation score calculated in operation 870 is a current reputation score that represents a non-consecutive reduction (e.g., a reduction that immediately follows an increase) in the quantified likelihood that the first entity (e.g., user 132) will successfully participate in future interaction events with other entities. In operation 970, based on the non-consecutive reduction in the quantified likelihood, the reputation reporter 230 determines that the first entity is to be excluded from receiving any notification of its corresponding current reputation score. That is, the reputation reporter 230 may determine that the first entity will not receive any notification of his or her current reputation score, based on that current reputation score indicating the start of a new downward trend in the reputation score for the first entity.

According to certain example embodiments, the reputation score calculated in operation 870 is a current reputation score that represents a twice-consecutive reduction (e.g., a second reduction that immediately follows a first reduction) in the quantified likelihood that the first entity (e.g., user 132) will successfully participate in future interaction events with other entities. In operation 980, based on the twice-consecutive reduction in the quantified likelihood, the reputation reporter 230 provides a notification of the calculated current reputation score exclusively to a device of the first entity (e.g., device 130 of user 132). That is, the reputation reporter 230 may determine that only the first entity will be notified (e.g., privately) that his or her reputation score has dropped two times in a row and accordingly provide a notification that communicates this circumstance along with his or her reputation score.

According to various example embodiments, the reputation score calculated in operation 870 is a current reputation score that represents a thrice reduction (e.g., a third reduction immediately following a second reduction that immediately follows a first reduction) in the quantified likelihood that the first entity (e.g., user 132) will successfully participate in future interaction events with other entities. In operation 990, based on the thrice-consecutive reduction in the quantified likelihood, the reputation reporter 230 provides a notification of the calculated current reputation score of the first entity to at least one device of at least one second entity (e.g., device 150 of user 152). That is, the reputation reporter 230 may determine that entities beyond the first entity will be notified (e.g., publicly or semi-privately) that the reputation score of the first entity has dropped three times in a row and accordingly provide a notification that communicates this circumstance along with the first entity's current reputation score to at least one second entity. In some situations, this notification is provided to the device of the first entity (e.g., device 130 of the user 132) as well. In some example embodiments, such a notification also indicates an opportunity (e.g., suggestion, recommendation, or invitation) for the first entity to improve their reputation score by requesting a vouch from another entity (e.g., user 152) that has a higher reputation score, that has a close relationship with the first entity (e.g., geodesically close within the reputation graph), or both.

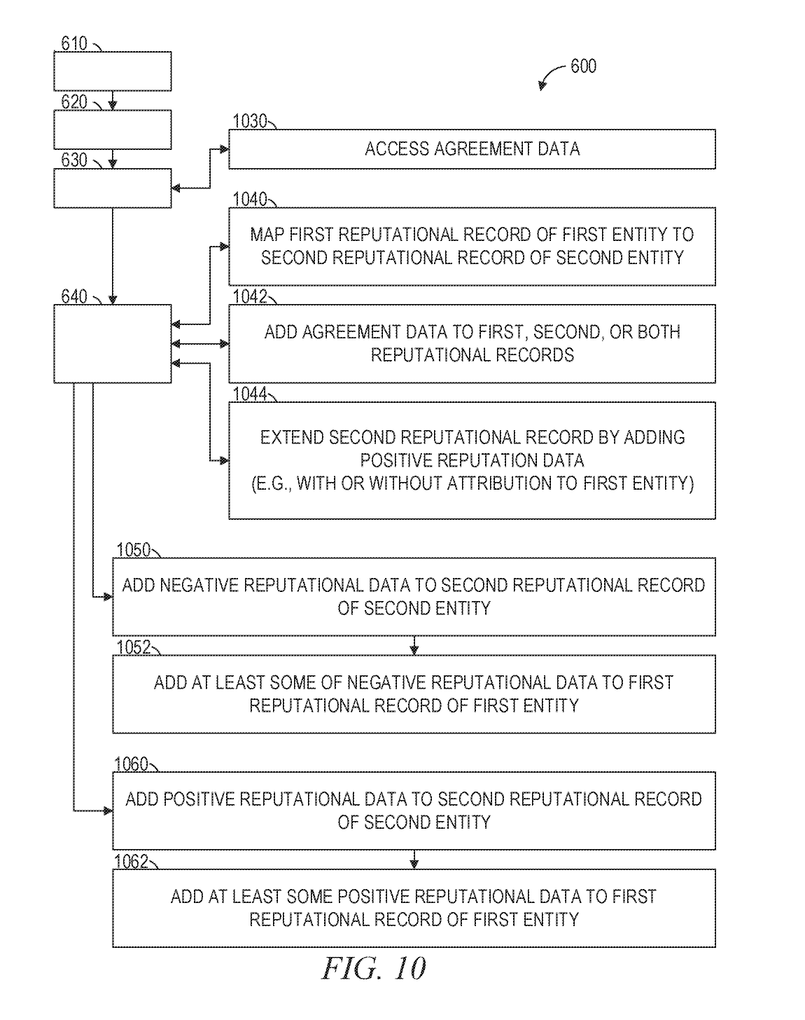

As shown in FIG. 10, in addition to any one or more of the operations previously described, the method 600 may include one or more of operations 1030, 1040, 1042, 1044, 1050, 1052, 1060, and 1062. Operation 1030 may be performed as part (e.g., a precursor task, a subroutine, or a portion) of operation 630, in which the database interface 220 accesses the event participation data for the interaction that was indicated as having been completed. In operation 1030, as part of accessing the event participation data, the database interface 220 accesses agreement data indicating that a first entity (e.g., user 132) is willing to risk entry of negative reputational data into his or her reputational record (e.g., a first reputational record, such as reputational record 400) in exchange for attribution of positive reputational data to be included in the reputational record (e.g., a second reputational record, such as reputational record 520 or 522) of a second entity (e.g., user 152). In some example embodiments, both the first and second entities are actual participants in the interaction event indicated as having occurred. Indeed, the interaction event may include an agreement (e.g., an active agreement) by the first entity to provide reputational support to the second entity.

Accordingly, in operation 1030, the agreement data accessed by the database interface 220 may be or include an indication of the willingness by the first entity to risk the possibility of accepting an adverse effect on his or her own reputation score in exchange for the ability to vouch for the second entity. In some cases, the first entity has a long-established reputational record (e.g., reputational record 400) and a relatively high reputation score, while the second entity lacks such a long-established reputational record (e.g., reputational record 520 or 522, which may be a newly generated reputational record that encodes little or no history of completed interaction events in which the second entity participated). In certain situations, the second entity has an established reputational record but has recently experienced an increase or decrease in their reputation score large enough (e.g., beyond a predetermined threshold delta value) to warrant validation.

One or more of operations 1040, 1042, and 1044 may be performed as part of operation 640, in which the database interface 220 updates the distributed reputational database 500. Moreover, any one or more of operations 1040, 1042, and 1044 may be performed in response to the performance of operation 1030, in which the agreement data (e.g., indicative of a vouching agreement between the first and second entities) was accessed.

In operation 1040, as part of updating the distributed reputational database 500, the database interface 220 maps the reputational record (e.g., first reputational record, such as reputational record 400) of the first entity (e.g., user 132) to the reputational record (e.g., second reputational record, such as reputational record 520 or 522) of the second entity (e.g., user 152). The mapping may be performed by modifying one or both reputational records such that a correspondence relationship (e.g., a link, a reference, or a pointer) exists between these two reputational records and is indicated within the distributed reputational database 500. Moreover, this mapping may be performed based on the agreement data accessed in operation 1030.

In operation 1042, as part of updating the distributed reputational database 500, the database interface 220 extends the reputational record (e.g., first reputational record) of the first entity (e.g., user 132), the reputational record (e.g., second reputational record) of the second entity (e.g., user 152), or both, by adding (e.g., inserting) at least some of the agreement data to the reputational record (e.g., first reputational record) of the first entity (e.g., user 132), the reputational record (e.g., second reputational record) of the second entity (e.g., user 152), or both. In some example embodiments the presence of at least some of the agreement data within one or both of these reputational records is indicative of the vouching relationship between the first and second entities.

In operation 1044, as part of updating the distributed reputational database 500, the database interface 220 extends the reputational record (e.g., second reputational record) of the second entity (e.g., user 152) by adding (e.g., inserting) the agreed-upon positive reputational data (e.g., as discussed above with respect to operation 1030) into that reputational record. This may be performed by adding a new portion to the second entity's reputational record, in a manner similar to that described above with respect to FIG. 4. According to various example embodiments, the positive reputational data may take the form of any information that is attributable to the first entity (e.g., user 132, as the vouching entity) and has the effect of improving (e.g., raising) the current reputation score of the second entity (e.g., user 152, as the beneficiary of the vouching agreement). In some example embodiments, the extending of the second entity's reputational record includes adding an entity identifier that identifies the first entity (e.g., vouching entity), where the added entity identifier of the first entity indicates that the positive reputational data is attributed to the first entity.

According to various example embodiments, reputation scores for the first and second entities (e.g., users 132 and 152, as vouching entity and beneficiary entity, respectively) rise and fall together, though not necessarily by the same amount. The combination of operations 1050 and 1052 is performed when the reputation scores for the first and second entities fall together (e.g., by different amounts or by the same amount).

In operation 1050, the database interface 220 extends the reputational record (e.g., second reputational record) of the second entity (e.g., user 152) by adding negative reputational data into that reputational record. For example, the negative reputational data may arise (e.g., in a manner similar to that described above with respect to operation 630) from one or more subsequent interaction events in which the second entity is scheduled to participate. This addition of the negative reputational data may be performed by adding a new portion to the second entity's reputational record, in a manner similar to that described above with respect to FIG. 4. According to various example embodiments, the negative reputational data may take the form of any information that has the effect of degrading (e.g., lowering) the current reputation score of the second entity (e.g., user 152).

In operation 1052, an analogous process is performed with respect to the first entity (e.g., user 132, as the vouching entity). Specifically, in operation 1052, the database interface 220 extends the reputational record (e.g., first reputational record) of the first entity (e.g., user 132) by adding at least some of the negative reputational data discussed above with respect to operation 1050 into the first entity's reputational record. Moreover, this addition of at least some of the negative reputational data may be based on the agreement data accessed in operation 1030.

The combination of operations 1060 and 1062 is performed when reputation scores for the first and second entities rise together (e.g., by different amounts or by the same amount). In operation 1060, the database interface 220 extends the reputational record (e.g., second reputational record) of the second entity (e.g., user 152) by adding further positive reputational data into that reputational record. For example, this further positive reputational data may arise (e.g., in a manner similar to that described above with respect operation 630) from one or more subsequent interaction events in which the second entity is scheduled to participate. This addition of the further positive reputational data may be performed by adding a new portion to the second entity's reputational record, in a manner similar to that described above with respect to FIG. 4. According to various example embodiments, the further positive reputational data may take the form of any information that has the effect of improving (e.g., enhancing) the current reputation score of the second entity (e.g., user 152).

In operation 1062, an analogous process is performed with respect to the first entity (e.g., user 132, as the vouching entity). In particular, in operation 1062, the database interface 220 extends the reputational record (e.g., first reputational record) of the first entity (e.g., user 132) by adding at least some of the further positive reputational data discussed above with respect to operation 1060 into the first entity's reputational record. Moreover, this addition of at least some of the further positive reputational data may be based on the agreement data accessed in operation 1030.

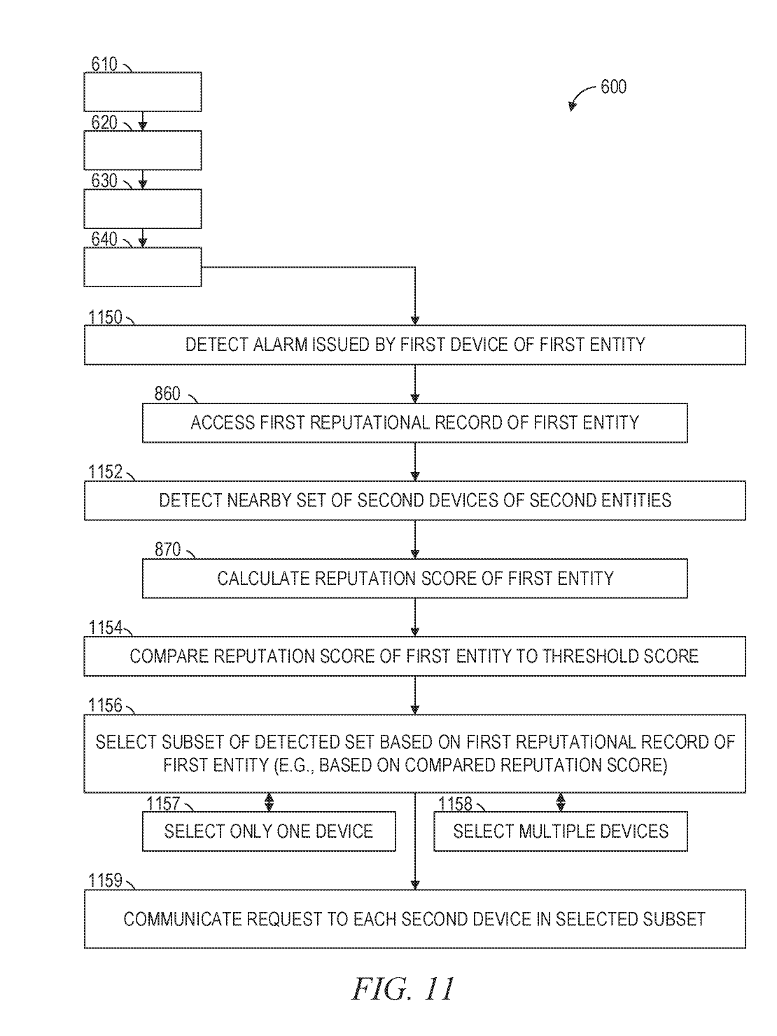

As shown in FIG. 11, in addition to any one or more of the operations previously described, the method 600 may include one or more of operations 1150, 1152, 1154, 1156, 1157, 1158, and 1159. These operations are illustrated in conjunction with operations 860 and 870, which are performed in a manner similar to that described previously with respect to FIG. 8.

In operation 1150, the alarm handler 240 detects that an alarm has been issued (e.g., raised, communicated, or otherwise indicated) by a first device (e.g., device 130) that corresponds to a first entity identifier (e.g., a user name or globally unique identification code) of a first entity (e.g., user 132). For example, the alarm handler 240 may detect the alarm by accessing (e.g., receiving) the alarm or an indicator thereof.

In some example embodiments, the first entity is included among the entities that actually participated in the interaction event and whose reputational records (e.g., group 530 of reputational records) were each extended during the updating of the distributed reputational database 500 in operation 640. In alternative example embodiments, the first entity is included among the entities that were scheduled to participate in the interaction event but did not actually participate therein. In further alternative example embodiments, the first entity has a reputational record (e.g., reputational record 522 or similar) in the distributed reputational database 500 but was not scheduled to participate in the interaction event and did not participate therein.

As shown in FIG. 11, an instance of operation 860 may be performed by the alarm handler 240 after operation 1150. Accordingly, the alarm handler 240 may access a first reputational record (e.g., reputational record 400) of the first entity (e.g., user 132), and the accessing of the first reputational record may be based on (e.g., in response to) the first entity identifier of the first entity, as detected by the alarm handler 240 during performance of operation 1150.

In operation 1152, the alarm handler 240 detects that a set of one or more second devices (e.g., device 150) that correspond to one or more second entities (e.g., user 152) is located within a predetermined threshold geographical distance (e.g., within a maximum distance or within a range of distances) of the first device (e.g., device 130) that issued the alarm detected in operation 1150. This may have the effect of identifying those second devices that are geographically nearby the first device.

As used herein, geographical distance is an example of geodesic distance, which also encompasses network geodesic distance, such as temporal distance and domain distance. In some example embodiments, the alarm handler 240 uses one or more forms of geodesic distance (e.g., in terms of physical proximity or nodal proximity within a network) within the reputational graph represented by the distributed reputational database 500 in performing operation 1152. For example, the alarm handler 240 can use geographical distance (e.g., geographical proximity), temporal distance (e.g., temporal proximity), domain distance (e.g., domain proximity), or any suitable combination thereof. Accordingly, although the term “geographical distance” is used consistently herein for clarity, any one or more forms of geodesic distance may be similarly used instead.

As shown in FIG. 11, an instance of operation 870 may be performed by the alarm handler 240 after operation 1152. Accordingly, the alarm handler 240 may calculate a current reputation score of the first entity (e.g., user 132) identified by the first entity identifier, and the calculating of the current reputation score may be based on the accessed first reputational record of the first entity (e.g., as accessed in the above-discussed instance of operation 860).

In operation 1154, the alarm handler 240 compares the reputation score of the first entity (e.g., user 132) to a predetermined threshold reputation score. For example, the predetermined threshold reputation score may be a minimum reputation score that indicates a boundary between relatively high-scoring entities and relatively low scoring entities. Furthermore, the predetermined threshold reputation score may be stored at any one or more locations within the network-based system 105 (e.g., stored within a data structure contained in the application 200 or any one or more modules thereof).

In operation 1156, the alarm handler 240 selects a subset of the set of second devices that were detected in operation 1152. The selecting of the subset may be based on the first reputational record (e.g., reputational record 400) of the first entity (e.g., user 132), the calculated current reputation score of the first entity (e.g., as calculated in the above-discussed instance of operation 870), or any suitable combination thereof. The size of the selected subset can vary depending on the results of the comparison performed in operation 1154.

For example, if the current reputation score of the first entity (e.g., user 132) meets or exceeds the predetermined threshold reputation score, the alarm handler 240 may treat the first entity as a relatively reliable issuer of alarms with a relatively high current reputation score and accordingly select a relatively low number of nearby second devices (e.g., device 150 only) for communicating a request to verify or investigate the issued alarm. As an alternative example, if the current reputation score of the first entity fails to meet the predetermined threshold reputation score, the alarm handler 240 may treat the first entity as a relatively unreliable issuer of alarms with a relatively low current reputation score and accordingly select a relatively high number of nearby second devices (e.g., device 150, plus one or more other devices) for communicating a request to verify or investigate the issued alarm. Accordingly, for each instance of operation 1156, either operation 1157 is performed as part of operation 1156, or operation 1158 is performed as part of operation 1156.

In some situations, the alarm detected in operation 1150 may affect (e.g., raise or lower) the reputation score of an entity (e.g., a location, such as a restaurant) observed by the first entity (e.g., user 132). According to various example embodiments, the alarm handler 240 may perform an analysis of previous (e.g., 5 or 10 most recent) changes to the reputation score of the observed entity. If that reputation score is falling unexpectedly (e.g., as indicated by nonlinear decreases), the alarm handler 240 may base its performance of operation 1156 on nodal proximity (e.g., geodesic closeness within a maximum geodesic distance) within the reputational graph represented by the distributed reputational database 500. Accordingly, an unexpectedly (e.g., nonlinearly) falling reputation would be validated by one or more entities that frequently interact with the observed entity (e.g., the restaurant). This may have the effect of giving more weight to those entities that know and understand the observed entity best.

On the other hand, if the reputation score is rising unexpectedly (e.g., as indicated by nonlinear increases), the alarm handler 240 may apply nodal distance (e.g., beyond a minimum geodesic distance) within the reputational graph. Thus, an unexpectedly (e.g., nonlinearly) rising reputation would be validated by one or more entities that seldom interact with the observed entity (e.g., the restaurant). This may have the effect of hampering concerted efforts (e.g., regaining) by zealous fans of the entity to artificially boost the entity's reputation.

In operation 1157, in selecting the subset of the set of detected second devices, the alarm handler 240 selects only one such second device (e.g., device 150 exclusively). As noted above, this selection may be made based on the current reputation score of the first entity (e.g., user 132) meeting or exceeding the predetermined threshold reputation score, as compared in operation 1154.

In operation 1158, in selecting the subset of the set of detected second devices, the alarm handler 240 selects multiple units of such second devices (e.g., device 150 and one or more additional devices detected within the predetermined threshold geographical distance of the first device of the first entity (e.g., device 130 of user 132)). As noted above, this selection may be made based on the current reputation score of the first entity failing to meet the predetermined threshold reputation score, as compared in operation 1154.

In operation 1159, having selected the subset of nearby second devices, the alarm handler 240 communicates a request to each second device in the selected subset. As noted above, the communicated requests may ask each corresponding second entity (e.g., user 152 of the device 150) to verify or investigate the alarm issued by the first device of the first entity (e.g., device 130 of the user 132).

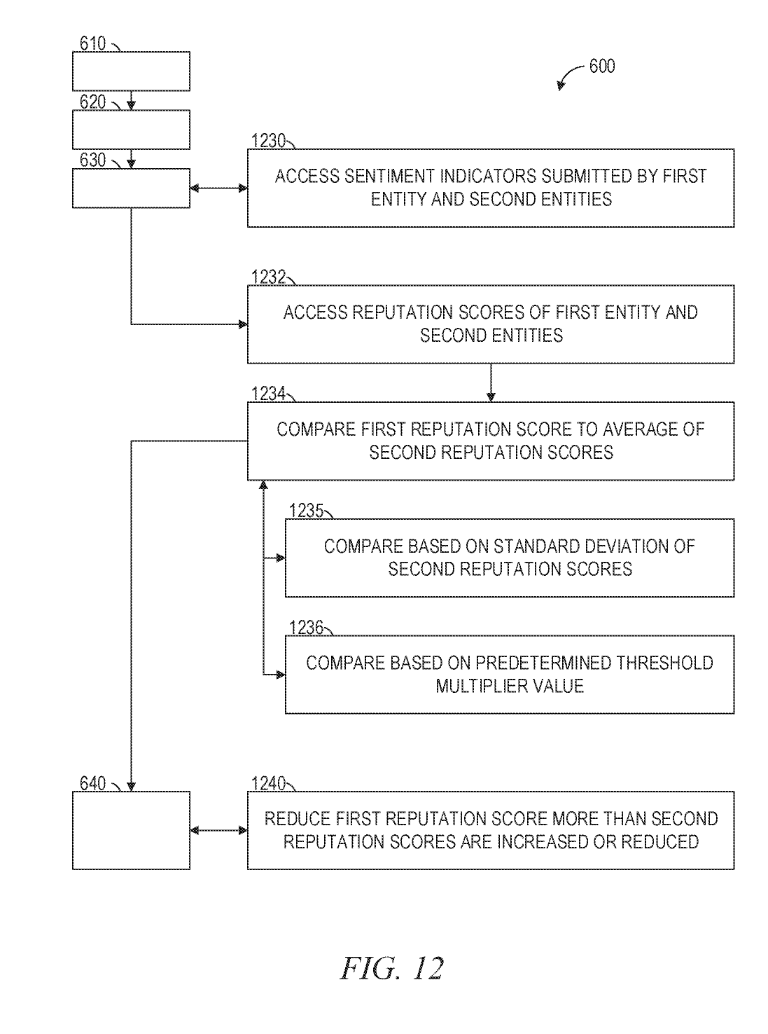

As shown in FIG. 12, in addition to any one or more of the operations previously described, the method 600 may include one or more of operations 1230, 1232, 1234, 1235, 1236, and 1240. Operation 1230 may be performed as part of operation 630, in which the database interface 220 accesses the event participation data for the interaction event indicated to have occurred. In operation 1230, as part of accessing the event participation data, the database interface 220 may access one or more sentiment indicators submitted by entities that actually participated in the interaction event. In some example embodiments, such sentiment indicators are included in the portions of event participation data submitted by a first entity (e.g., user 132, who participated in interaction event) and multiple second entities (e.g., user 152 and one or more other entities that participated in the interaction event).

For example, the event participation data accessed in operation 630 may include a first sentiment indicator that describes the interaction event and is submitted by the first entity, and the event participation data may further include multiple second sentiment indicators that each described the interaction event and are each submitted by a different second entity (e.g., user 152) among the multiple second entities. Furthermore, in some situations, the first sentiment indicator submitted by the first entity (e.g., user 132) deviates from (e.g., contradicts) the second sentiment indicators collectively submitted by the multiple second entities (e.g., user 152, plus one or more other entities that participate in interaction event). According to various example embodiments, examples of sentiment indicators include ratings (e.g., on a like-dislike scale, a 5-star scale, a 10-point scale, or a good-neutral-bad scale), text descriptors (e.g., selected from a predetermined set of available descriptors), other descriptive feedback regarding the success or failure of interaction event (e.g., emoji or other icons), or any suitable combination thereof.

As shown in FIG. 12, one or more of operations 1232, 1234, 1235, and 1236 may be performed between operation 630 and operation 640. In operation 1232, the database interface 220 accesses (e.g., retrieves or calculates) the reputation scores of the first entity (e.g., user 132) and the multiple second entities (e.g., user 152, plus one or more other entities that participated in the interaction event). Where calculation of such reputation scores is performed, the reputation scores can be calculated in a manner similar to that described above with respect to operation 870. Alternatively, if already calculated, such reputation scores may be accessed directly (e.g., from storage within the distributed reputational database 500 or within one or more machines in the network-based system 105).

In operation 1234, the database interface 220 compares the first reputation score of the first entity (e.g., user 132) to a representative score derived from the second reputation scores of the multiple second entities. According to various example embodiments, the representative score may be an arithmetic mean score (e.g., average score), a statistical median score, a weighted average score, or other representative value that indicates the collective sentiment of the multiple second entities regarding the interaction event. As shown in FIG. 12, one or both of operations 1235 and 1236 may be performed as part of operation at 1234.

In operation 1235, the database interface 220 performs the comparison of the first reputation score to the representative score based on a standard deviation calculated from the second reputation scores of the multiple second entities. In operation 1236, the database interface 220 performs the comparison based on a predetermined threshold multiplier value that corresponds to the standard deviation. Such a predetermined threshold multiplier value may be stored at any one or more locations within the network-based system 105 (e.g., stored within a data structure contained in the application 200 or any one or more modules thereof).

Accordingly, with the combined performance of operations 1235 and 1236, performance of operation 1234 may result in the database interface 220 determining that the first reputation score of the first entity (e.g., user 132) minus the representative score (e.g., the average of the second reputation scores of the multiple second entities) exceeds the standard deviation of the second reputation scores by the predetermined threshold multiplier value. In such a case, the database interface 220 may treat the first reputation score as being significantly higher than the second reputation scores, viewed collectively as an aggregate. That is, under these conditions, the database interface 220 may treat the first entity (e.g., user 132) as being significantly more reputable than the multiple second entities (e.g., user 152, plus one or more other entities that participated in the interaction event).

Accordingly, where the first entity (e.g., user 132) has been deemed to have a significantly higher reputation relative to the aggregate of the multiple second entities (e.g., user 152, plus one or more other entities that participated in the interaction event), operation 1240 may be performed as part of operation 640, in which the database interface 220 updates the distributed reputational database 550.

In operation 1240, the database interface 220 applies a deviation penalty to the first reputation score of the first entity (e.g., user 132) for submitting a sentiment indicator that deviates from (e.g., contradicts) the second sentiment indicators collectively submitted by the multiple second entities (e.g., user 152, plus one or more other entities that participate in interaction event). In some example embodiments, the database interface 220 performs processing similar to that discussed above with respect to operations 1234-1236 to determine whether the deviation is significant enough to be treated as contradictory to the second sentiment indicators.

For example, if all sentiment indicators accessed in operation 1230 are negative, all reputation scores of the participating entities may be reduced to reflect lack of success (e.g., failure) experienced at the interaction event. However, since the first entity's first reputation score is significantly higher than the second reputation scores of the second entities, the first entity's first reputation score may be reduced by a first penalty amount that is greater than a second penalty amount by which the second reputation scores are reduced.

As another example, if all of the second sentiment indicators from the second entities are positive, but the first sentiment indicator from the first entity is negative, the reputation scores of the second entities may be increased to reflect success experience at the interaction event. However, since the first entity's first reputation score is significantly higher than the second reputation scores of the second entities, the first entity's first reputation score may be reduced by a first penalty amount that is greater than a second enhancement amount by which the second reputation scores are increased.

According to various example embodiments, one or more of the methodologies described herein may facilitate full or partial generation, storage, maintenance, management, and use of the distributed reputational database 500. Moreover, one or more of the methodologies described herein may facilitate generation, storage, maintenance, modification, retrieval, and use of one or more reputational records (e.g., reputational records 510) that each encode a different history of completed events in which a corresponding different entity was scheduled to participate or in which the corresponding different entity actually participated. Hence, one or more of the methodologies described herein may facilitate generation, storage, tracking, and provision of one or more current reputation scores that each describe a corresponding different entity and may be used as a predictor of the likelihood that the corresponding different entity will be successful in future interaction events with other entities, as well as implementation of one or more notification or alarm handling services based on such current reputation scores, compared to capabilities of pre-existing systems and methods.

When these effects are considered in aggregate, one or more of the methodologies described herein may obviate a need for certain efforts or resources that otherwise would be involved in generation, storage, maintenance, modification, retrieval, and use of the distributed reputational database 500. Efforts expended by a user in accessing, managing, or using reputational data (e.g., as stored in the distributed reputational database 500) may be reduced by use of (e.g., reliance upon) a special-purpose machine that implements one or more of the methodologies described herein. Computing resources used by one or more systems or machines (e.g., within the network environment 100) may similarly be reduced (e.g., compared to systems or machines that lack the structures discussed herein or are otherwise unable to perform the functions discussed herein). Examples of such computing resources include processor cycles, network traffic, computational capacity, main memory usage, graphics rendering capacity, graphics memory usage, data storage capacity, power consumption, and cooling capacity. In addition, since each machine, database, or device within the network environment 100 may have its own reputation score, each machine, database, or device may be utilized (e.g., prioritized) based on its reputation score, its proximity to an interaction event (e.g., nodal proximity within the reputation graph represented by the distributor relational database 500), or any suitable combination thereof.

In some example embodiments, multiple individual devices (e.g., devices 130 and 150) are configured to function as a distributed peer-to-peer network performing various portions of the method 600 as part of managing the distributed reputational database 500 (e.g., by contributing processing power or other computing resources). Each device performing such configured functions may do so in exchange for a predetermined increase in the reputation score of its corresponding entity (e.g., users 132 and 152), as an incentive for contributing to the performance of the method 600.

In some example embodiments, the difficulty of cryptographic work assigned to a device is automatically adjusted based on the reputation of the device. Accordingly, a device with a low reputation will be given more computationally intensive portions of the method 600 than a device with a high reputation, and the device with the low reputation will take longer to perform its assigned portions of the method 600. This may have the effect of protecting the distributed reputational database 500 from attacks by low-reputation devices. This may also have the effect of providing incentivizing use of higher reputation devices. In situations where devices can perform such processing tasks commercially (e.g., for cryptocurrency payments or other fees), devices with high reputations can accordingly generate more revenue by virtue of processing more tasks in processing such tasks faster than devices with low reputations.

In certain example embodiments, the distributed reputational database 500 is configured to store timestamped reputational data (e.g., with or without calculation of corresponding reputation scores) for later verification and potential subsequent use. Such reputational data may be stored on one or more machines within the network-based system 105, and the machine (e.g., device 150) used for such storage may be selected in response to a corresponding entity (e.g., user 152) agreeing to vouch for the accuracy of the reputational data. In the event that the reputational data is later found to be incorrect (e.g., fraudulent), a penalty to the reputation score of that entity (e.g., user 152) may be applied in a manner similar to that discussed above with respect to FIG. 12.

In various example embodiments, the distributed reputational database 500 is configured to support one or more augmented reality applications. For example, if the device 130 detects that it is geographically near an entity (e.g., a location of a venue or a location of the device 150), an entity identifier that corresponds the entity may be presented (e.g., displayed) by the device 130, along with some reputationally relevant information regarding that entity (e.g., its reputation score, or some portion of its reputational record). The presentation of the entity identifier, the reputationally relevant information, or both, may be triggered by some user input (e.g., a touch or a click) provided by the user 132 of the device 130. Accordingly, an augmented reality application may configure the device 130 to present multiple reputationally relevant annotations for multiple entities (e.g., objects, people, streets, or buildings) that are geographically near the device 130 (e.g., within a viewing frustum of a camera controlled by the device 130).

FIG. 13 is a block diagram illustrating components of a machine 1300, according to some example embodiments, able to read instructions 1324 from a machine-readable medium 1322 (e.g., a non-transitory machine-readable medium, a machine-readable storage medium, a computer-readable storage medium, or any suitable combination thereof) and perform any one or more of the methodologies discussed herein, in whole or in part. Specifically, FIG. 13 shows the machine 1300 in the example form of a computer system (e.g., a computer) within which the instructions 1324 (e.g., software, a program, an application, an applet, an app, or other executable code) for causing the machine 1300 to perform any one or more of the methodologies discussed herein may be executed, in whole or in part.

In alternative embodiments, the machine 1300 operates as a standalone device or may be communicatively coupled (e.g., networked) to other machines. In a networked deployment, the machine 1300 may operate in the capacity of a server machine or a client machine in a server-client network environment, or as a peer machine in a distributed (e.g., peer-to-peer) network environment. The machine 1300 may be a server computer, a client computer, a personal computer (PC), a tablet computer, a laptop computer, a netbook, a cellular telephone, a smart phone, a set-top box (STB), a personal digital assistant (PDA), a web appliance, a network router, a network switch, a network bridge, or any machine capable of executing the instructions 1324, sequentially or otherwise, that specify actions to be taken by that machine. Further, while only a single machine is illustrated, the term “machine” shall also be taken to include any collection of machines that individually or jointly execute the instructions 1324 to perform all or part of any one or more of the methodologies discussed herein.

The machine 1300 includes a processor 1302 (e.g., one or more central processing units (CPUs), one or more graphics processing units (GPUs), one or more digital signal processors (DSPs). one or more application specific integrated circuits (ASICs), one or more radio-frequency integrated circuits (RFICs), or any suitable combination thereof), a main memory 1304, and a static memory 1306, which are configured to communicate with each other via a bus 1308. The processor 1302 contains solid-state digital microcircuits (e.g., electronic, optical, or both) that are configurable, temporarily or permanently, by some or all of the instructions 1324 such that the processor 1302 is configurable to perform any one or more of the methodologies described herein, in whole or in part. For example, a set of one or more microcircuits of the processor 1302 may be configurable to execute one or more modules (e.g., software modules) described herein. In some example embodiments, the processor 1302 is a multicore CPU (e.g., a dual-core CPU, a quad-core CPU, an 8-core CPU, or a 128-core CPU) within which each of multiple cores behaves as a separate processor that is able to perform any one or more of the methodologies discussed herein, in whole or in part. Although the beneficial effects described herein may be provided by the machine 1300 with at least the processor 1302, these same beneficial effects may be provided by a different kind of machine that contains no processors (e.g., a purely mechanical system, a purely hydraulic system, or a hybrid mechanical-hydraulic system), if such a processor-less machine is configured to perform one or more of the methodologies described herein.

The machine 1300 may further include a graphics display 1310 (e.g., a plasma display panel (PDP), a light emitting diode (LED) display, a liquid crystal display (LCD), a projector, a cathode ray tube (CRT), or any other display capable of displaying graphics or video). The machine 1300 may also include an alphanumeric input device 1312 (e.g., a keyboard or keypad), a pointer input device 1314 (e.g., a mouse, a touchpad, a touchscreen, a trackball, a joystick, a stylus, a motion sensor, an eye tracking device, a data glove, or other pointing instrument), a data storage 1316, an audio generation device 1318 (e.g., a sound card, an amplifier, a speaker, a headphone jack, or any suitable combination thereof), and a network interface device 1320.

The data storage 1316 (e.g., a data storage device) includes the machine-readable medium 1322 (e.g., a tangible and non-transitory machine-readable storage medium) on which are stored the instructions 1324 embodying any one or more of the methodologies or functions described herein. The instructions 1324 may also reside, completely or at least partially, within the main memory 1304, within the static memory 1306, within the processor 1302 (e.g., within the processor's cache memory), or any suitable combination thereof, before or during execution thereof by the machine 1300. Accordingly, the main memory 1304, the static memory 1306, and the processor 1302 may be considered machine-readable media (e.g., tangible and non-transitory machine-readable media). The instructions 1324 may be transmitted or received over the network 190 via the network interface device 1320. For example, the network interface device 1320 may communicate the instructions 1324 using any one or more transfer protocols (e.g., hypertext transfer protocol (HTTP)).

In some example embodiments, the machine 1300 may be a portable computing device (e.g., a smart phone, a tablet computer, or a wearable device), and may have one or more additional input components 1330 (e.g., sensors or gauges). Examples of such input components 1330 include an image input component (e.g., one or more cameras), an audio input component (e.g., one or more microphones), a direction input component (e.g., a compass), a location input component (e.g., a global positioning system (GPS) receiver, sensor fusion, a beacon detector, or a wireless network transceiver), an orientation component (e.g., a gyroscope), a motion detection component (e.g., one or more accelerometers), an altitude detection component (e.g., an altimeter), a temperature input component (e.g., a thermometer), a gas detection component (e.g., a gas sensor), and a biometric detection component (e.g., one or more biometric sensors that monitor heart rate, breathing rate, galvanic skin response, body temperature, blood sugar level, or other biological indicators). Input data gathered by any one or more of these input components may be accessible and available for use by any of the modules described herein (e.g., with suitable privacy notifications and protections, such as opt-in consent or opt-out consent, implemented in accordance with user preference, applicable regulations, or any suitable combination thereof).

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1322 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of carrying (e.g., storing or communicating) the instructions 1324 for execution by the machine 1300, such that the instructions 1324, when executed by one or more processors of the machine 1300 (e.g., processor 1302), cause the machine 1300 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible and non-transitory data repositories (e.g., data volumes) in the example form of a solid-state memory chip, an optical disc, a magnetic disc, or any suitable combination thereof.

A “non-transitory” machine-readable medium, as used herein, specifically excludes propagating signals per se. According to various example embodiments, the instructions 1324 for execution by the machine 1300 can be communicated via a carrier medium (e.g., a machine-readable carrier medium). Examples of such a carrier medium include a non-transient carrier medium (e.g., a non-transitory machine-readable storage medium, such as a solid-state memory that is physically movable from one place to another place) and a transient carrier medium (e.g., a carrier wave or other propagating signal that communicates the instructions 1324).

Certain example embodiments are described herein as including modules. Modules may constitute software modules (e.g., code stored or otherwise embodied in a machine-readable medium or in a transmission medium), hardware modules, or any suitable combination thereof. A “hardware module” is a tangible (e.g., non-transitory) physical component (e.g., a set of one or more processors) capable of performing certain operations and may be configured or arranged in a certain physical manner. In various example embodiments, one or more computer systems or one or more hardware modules thereof may be configured by software (e.g., an application or portion thereof) as a hardware module that operates to perform operations described herein for that module.

In some example embodiments, a hardware module may be implemented mechanically, electronically, hydraulically, or any suitable combination thereof. For example, a hardware module may include dedicated circuitry or logic that is permanently configured to perform certain operations. A hardware module may be or include a special-purpose processor, such as a field programmable gate array (FPGA) or an ASIC. A hardware module may also include programmable logic or circuitry that is temporarily configured by software to perform certain operations. As an example, a hardware module may include software encompassed within a CPU or other programmable processor. It will be appreciated that the decision to implement a hardware module mechanically, hydraulically, in dedicated and permanently configured circuitry, or in temporarily configured circuitry (e.g., configured by software) may be driven by cost and time considerations.

Accordingly, the phrase “hardware module” should be understood to encompass a tangible entity that may be physically constructed, permanently configured (e.g., hardwired), or temporarily configured (e.g., programmed) to operate in a certain manner or to perform certain operations described herein. Furthermore, as used herein, the phrase “hardware-implemented module” refers to a hardware module. Considering example embodiments in which hardware modules are temporarily configured (e.g., programmed), each of the hardware modules need not be configured or instantiated at any one instance in time. For example, where a hardware module includes a CPU configured by software to become a special-purpose processor, the CPU may be configured as respectively different special-purpose processors (e.g., each included in a different hardware module) at different times. Software (e.g., a software module) may accordingly configure one or more processors, for example, to become or otherwise constitute a particular hardware module at one instance of time and to become or otherwise constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory (e.g., a memory device) to which it is communicatively coupled. A further hardware module may then, at a later time, access the memory to retrieve and process the stored output. Hardware modules may also initiate communications with input or output devices, and can operate on a resource (e.g., a collection of information from a computing resource).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module in which the hardware includes one or more processors. Accordingly, the operations described herein may be at least partially processor-implemented, hardware-implemented, or both, since a processor is an example of hardware, and at least some operations within any one or more of the methods discussed herein may be performed by one or more processor-implemented modules, hardware-implemented modules, or any suitable combination thereof.

Moreover, such one or more processors may perform operations in a “cloud computing” environment or as a service (e.g., within a “software as a service” (SaaS) implementation). For example, at least some operations within any one or more of the methods discussed herein may be performed by a group of computers (e.g., as examples of machines that include processors), with these operations being accessible via a network (e.g., the Internet) and via one or more appropriate interfaces (e.g., an application program interface (API)). The performance of certain operations may be distributed among the one or more processors, whether residing only within a single machine or deployed across a number of machines. In some example embodiments, the one or more processors or hardware modules (e.g., processor-implemented modules) may be located in a single geographic location (e.g., within a home environment, an office environment, or a server farm). In other example embodiments, the one or more processors or hardware modules may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and their functionality presented as separate components and functions in example configurations may be implemented as a combined structure or component with combined functions. Similarly, structures and functionality presented as a single component may be implemented as separate components and functions. These and other variations, modifications, additions, and improvements fall within the scope of the subject matter herein.

Some portions of the subject matter discussed herein may be presented in terms of algorithms or symbolic representations of operations on data stored as bits or binary digital signals within a memory (e.g., a computer memory or other machine memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “accessing,” “processing,” “detecting,” “computing,” “calculating,” “determining,” “generating,” “presenting,” “displaying,” or the like refer to actions or processes performable by a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

The following enumerated embodiments describe various example embodiments of methods, machine-readable media, and systems (e.g., machines, devices, or other apparatus) discussed herein.

A first embodiment provides a method comprising:

receiving, by one or more processors of a machine, an indication that an interaction event with scheduled participation by a plurality of entities has occurred;
accessing, by one or more processors of the machine, a distributed database that stores a plurality of reputational records, each reputational record in the plurality of reputational records encoding a different history of completed events in which participation by a corresponding different entity among the plurality of entities had been scheduled;
accessing, by one or more processors of the machine, event participation data that describes actual participation by the plurality of entities in the interaction event indicated to have occurred; and
updating, by one or more processors of the machine, the distributed database by extending each of the plurality of reputational records that each encodes a different history of completed events in which participation by a corresponding different entity among the plurality of entities had been scheduled, the extending of each reputational record being based on the accessed event participation data and in response to the receiving of the indication that the interaction event has occurred.

A second embodiment provides a method according to the first embodiment, wherein:

in the updating of the distributed database, the extending of each reputational record in the plurality of reputational records includes:
generating a hash based on a first portion of the corresponding history of completed events for the reputational record, the generated hash identifying the first portion, the identified first portion encoding a description of a completed event most recently precedent to the interaction event; and
generating a second portion of the corresponding history of completed events and adding the second portion to the corresponding history of completed events, the added second portion encoding a description of the interaction event and including the generated hash that identifies the first portion. This may have the effect of extending a reputational record in the example form of a blockchain by adding a block of data to the blockchain.

A third embodiment provides a method according to the first embodiment or the second embodiment, the method further comprising:

generating a reputational record that corresponds to the interaction event based on at least a subset of the extended reputational records that correspond to the plurality of entities scheduled to participate in the interaction event, the subset corresponding to entities whose actual participation in the interaction event is described by the event participation data; and
updating the distributed database by adding the generated reputational record of the interaction event to the distributed database. This may have the effect of providing a reputational record for the interaction event itself (e.g., for tracking the reputation of repeating instances of the interaction event going forward).

A fourth embodiment provides a method according to any of the first through third embodiments, the method further comprising:

accessing a reputational record that corresponds to a location of the interaction event; and
updating the distributed database by extending the reputational record that corresponds to the location of the interaction event based on the event participation data. This may have the effect of enabling the location (e.g., a street, an alleyway, a park, a building, or other venue) of the interaction event to have its own reputational record, as well as updating the reputational record of the location based on the event participation data for the interaction event that occurred at that location.

A fifth embodiment provides a method according to any of the first through fourth embodiments, wherein:

the interaction event includes a meeting (e.g., attendance at the meeting by various participant persons);
the indication that the interaction event has occurred indicates that the meeting has occurred;
the plurality of entities includes a plurality of persons scheduled to attend the meeting;
the event participation data describes actual attendance by the plurality of persons scheduled to attend the meeting; and
the extending of each reputational record is based on the actual attendance by the plurality of persons and in response to the receiving of the indication that the meeting has occurred.

A sixth embodiment provides a method according to the fifth embodiment, the method further comprising:

generating a reputational record that corresponds to the meeting based on each of the extended reputational records that correspond to the plurality of persons whose actual attendance at the meeting is described by the event participation data; and
updating the distributed database by adding the generated reputational record that corresponds to the meeting to the distributed database. This may have the effect of providing a reputational record for the meeting itself (e.g., for tracking the reputation of repeating instances of the meeting going forward).

A seventh embodiment provides a method according to any of the first through sixth embodiments, wherein:

the interaction event includes a service (e.g., performance of a service by various contributing persons);
the indication that the interaction event has occurred indicates that the service has been performed;
the plurality of entities includes a plurality of contributors scheduled to perform the service;
the event participation data describes actual contributions by the plurality of contributors to performance of the service; and
the extending of each reputational record is based on the actual contributions by the plurality of contributors and in response to the receiving of the indication that the service has been performed.

An eighth embodiment provides a method according to the seventh embodiment, the method further comprising:

generating a reputational record that corresponds to the performed service based on each of the extended reputational records that correspond to the plurality of contributors whose actual contributions to performance of the service are described by the event participation data; and
updating the distributed database by adding the generated reputational record that corresponds to the performed service to the distributed database. This may have the effect of providing a reputational record for the service itself (e.g., for tracking the reputation of repeating performances of the service going forward).

A ninth embodiment provides a method according to any of the first through eighth embodiments, wherein:

the interaction event includes assembly of a product (e.g., product subsequently available for sale);
the indication that the interaction event has occurred indicates that the product has been assembled;
the plurality of entities includes a plurality of components of the product;
the event participation data describes characteristics of the plurality of components; and
the extending of each reputational record is based on the characteristics of the plurality of components and in response to the receiving of the indication that the product has been assembled.

A tenth embodiment provides a method according to the ninth embodiment, the method further comprising:

generating a reputational record that corresponds to the assembled product based on each of the extended reputational records that correspond to the plurality of components whose characteristics are described by the event participation data; and
updating the distributed database by adding the generated reputational record that corresponds to the assembled product to the distributed database. This may have the effect of providing a reputational record for the product itself (e.g., for tracking the collective reputation of multiple instances of the product going forward, or for tracking the individual reputation of a single instance of the product going forward).

An eleventh embodiment provides a method according to any of the first through tenth embodiments, wherein:

the interaction event includes preparation of a food (e.g., a dish to be served at a restaurant or delivered by a caterer);
the indication that the interaction event has occurred indicates that the food has been prepared;
the plurality of entities includes a plurality of ingredients of the food;
the event participation data describes characteristics of the plurality of ingredients; and
the extending of each reputational record is based on the characteristics of the plurality of ingredients and in response to the receiving of the indication that the food has been prepared.

The twelfth embodiment provides a method according to eleventh embodiment, the method further comprising:

generating a reputational record that corresponds to the prepared food based on each of the extended reputational records that correspond to the plurality of ingredients whose characteristics are described by the event participation data; and
updating the distributed database by adding the generated reputational record that corresponds to the prepared food to the distributed database. This may have the effect of providing a reputational record for the food itself (e.g., for tracking the collective reputation of multiple instances of the food going forward, or for tracking the individual reputation of a single instance of the food going forward).

A thirteenth embodiment provides a method according to any of the first through twelfth embodiments, the method further comprising:

receiving an entity identifier that identifies a first entity among the plurality of entities, the entity identifier being received from a device of a second entity;
accessing a first extended reputational record from the distributed database based on the entity identifier that identifies the first entity, the first extended reputational record encoding a history of completed events in which participation by the corresponding first entity had been scheduled;
calculating a reputation score of the first entity based on the accessed first extended reputational record that corresponds to the first entity, the calculated reputation score of the first entity quantifying a likelihood that the first entity will successfully participate in future interaction events; and
providing a notification of the calculated reputation score of the first entity to the device of the second entity in response to the receiving of the entity identifier from the device of the second entity. This may have the effect of providing a prediction of future success, future failure, or the likelihood of future success or future failure, for future interactions with the first entity.

A fourteenth embodiment provides a method according to any one of the first through thirteenth embodiments, the method further comprising:

calculating a current reputation score of a first entity among the plurality of entities based on a first extended reputational record that is included in the plurality of extended reputational records and that corresponds to the first entity, the current reputation score of the first entity quantifying a likelihood that the first entity will successfully participate in future interaction events, the current reputation score representing a non-consecutive reduction in the quantified likelihood; and
determining that the first entity is to be excluded from receiving notification of the current reputation score based on the current reputation score representing the non-consecutive reduction in the quantified likelihood. This may have the effect of limiting or reducing concern by the first entity over a single non-consecutive reduction in its reputation. An alternative embodiment may operate similarly for a single non-consecutive increase in the reputation of the first entity.

A fifteenth embodiment provides a method according to any one of the first through thirteenth embodiments, the method further comprising:

calculating a current reputation score of a first entity among the plurality of entities based on a first extended reputational record that is included in the plurality of extended reputational records and that corresponds to the first entity, the current reputation score of the first entity quantifying a likelihood that the first entity will successfully participate in future interaction events, the current reputation score representing a twice-consecutive reduction in the quantified likelihood; and
providing a notification of the calculated current reputation score of the first entity exclusively to a device of the first entity in response to the current reputation score representing the twice-consecutive reduction in the quantified likelihood. This may have the effect of alerting (e.g., warning) the first entity that two consecutive reductions in reputation have occurred, while limiting or reducing concern over this twice-consecutive reduction for other entities.

A sixteenth embodiment provides a method according to any one of the first through thirteenth embodiments, the method further comprising:

calculating a current reputation score of a first entity among the plurality of entities based on a first extended reputational record that is included in the plurality of extended reputational records and that corresponds to the first entity, the current reputation score of the first entity quantifying a likelihood that the first entity will successfully participate in future interaction events, the current reputation score representing a thrice-consecutive reduction in the quantified likelihood; and
providing a notification of the calculated current reputation score of the first entity to at least one device of at least one second entity in response to the current reputation score of the first entity representing the thrice-consecutive reduction in the quantified likelihood. This may have the effect of alerting (e.g., warning) the first entity that three consecutive reductions in reputation have occurred, while notifying one or more other entities that the first entity has had its reputation reduced three consecutive times.

A seventeenth embodiment provides a method according to any one of the first through sixteenth embodiments, wherein:

the interaction event includes an agreement by a first entity among the plurality of entities to provide reputational support to a second entity among the plurality of entities, the first entity corresponding to a first reputational record among the plurality of reputational records, the second entity corresponding to a second reputational record among the plurality of reputational records;
the event participation data includes agreement data that indicates the first entity is willing to risk entry of negative reputational data into the first reputational record of the first entity in exchange for attribution of positive reputational data to be included in the second reputational record of the second entity; and
the updating of the distributed database includes mapping the first reputational record of the first entity to the second reputational record of the second entity based on the agreement data included in the event participation data. This may have the effect of enabling one entity (e.g., with a relatively high reputation score) to vouch for another entity (e.g., with no reputation score or with a relatively low reputation score) and configuring the distributed database to implement and track the resulting vouching relationship between the two entities.

An eighteenth embodiment provides a method according to the seventeenth embodiment, wherein:

in the updating of the distributed database, the extending of each reputational record in the plurality of reputational records includes adding the agreement data to at least one of the first reputational record of the first entity or the second reputational record of the second entity. This may have the effect of storing the vouching agreement in one or both reputational records of the entities that are party to the vouching agreement.

A nineteenth embodiment provides a method according to the seventeenth embodiment or the eighteenth embodiment, wherein:

in the updating of the distributed database, the extending of each reputational record in the plurality of reputational records includes extending the second reputational record of the second entity by adding the positive reputational data to the second reputational record. This may have the effect of causing the reputation score of the second entity to be increased (e.g., become more positive).

A twentieth embodiment provides a method according to any one of the seventeenth through nineteenth embodiments, wherein:

in the updating of the distributed database, the extending of each reputational record in the plurality of reputational records includes extending the second reputational record of the second entity by adding an identifier of the first entity to the second reputational record of the second entity, the added identifier of the first entity attributing the positive reputational data to the first entity. This may have the effect of attributing the positive reputational data to the vouching entity.

A twenty-first embodiment provides a method according to any one of the seventeenth through twentieth embodiments, the method further comprising:

adding negative reputational data to the second reputational record of the second entity in response to a further interaction event in which the second entity participated but the first entity did not participate; and
adding at least a portion of the negative reputational data to the first reputational record of the first entity based on the agreement data that indicates the first entity is willing to risk entry of negative reputational data into the first reputational record of the first entity in exchange for attribution of the positive reputational data. This may have the effect of causing the reputation scores of the vouching entity and the vouched entity to be reduced together (e.g., in parallel, to the same degree or to different degrees).

A twenty-second embodiment provides a method according to any one of the seventeenth through twenty-first embodiments, the method further comprising:

adding further positive reputational data to the second reputational record of the second entity in response to a further interaction event in which the second entity participated but the first entity did not participate; and
adding at least a portion of the further positive reputational data to the first reputational record of the first entity based on the mapping of the first reputational record of the first entity to the second reputational record of the second entity. This may have the effect of causing the reputation scores of the vouching entity and the vouched entity to be increased together (e.g., in parallel, to the same degree or to different degrees).

A twenty-third embodiment provides a method according to any one of the first through twenty-second embodiments, the method further comprising:

detecting an alarm issued by a first device that corresponds to a first identifier of a first entity among the plurality of entities;
accessing a first extended reputational record from the distributed database based on the first identifier of the first entity, the first extended reputational record encoding a history of completed events in which participation by the corresponding first entity had been scheduled;
detecting that a set of second devices that correspond to second entities represented by the distributed database is within a predetermined threshold geodesic distance (e.g., geographical distance) of the first device that issued the detected alarm; selecting a subset of the detected set of second devices based on the first extended reputational record that corresponds to the first entity; and
communicating a request to each second device in the subset selected from the detected set of second devices, the communicated request asking each corresponding second entity to verify the alarm issued by the first device that corresponds to the first entity. This may have the effect of implementing an alarm verification scheme, in which the devices of one or more nearby entities are detected and the one or more nearby entities are asked to confirm or investigate an alarm raised by the first entity.

A twenty-fourth embodiment provides a method according to the twenty-third embodiment, the method further comprising:

calculating a current reputation score of the first entity based on the first extended reputational record accessed from the distributed database; and
comparing the calculated current reputation score of the first entity to a predetermined threshold reputation score; and wherein
the selecting of the subset of the detected set of second devices selects a single second device among the detected set of second devices based on the comparing of the calculated current reputation score to the predetermined threshold reputation score. This may have the effect of determining that the first entity has a relatively high reputation score and, in response to the relatively high reputation score, automatically choosing a relatively low number (e.g., one) of nearby entities for confirming or investigating the alarm raised by the first entity.

A twenty-fifth embodiment provides a method according to the twenty-third embodiment or the twenty-fourth embodiment, the method further comprising:

calculating a current reputation score of the first entity based on the first extended reputational record accessed from the distributed database; and
comparing the calculated current reputation score of the first entity to a predetermined threshold reputation score; and wherein
the selecting of the subset of the detected set of second devices selects a plurality of second devices among the detected set of second devices based on the comparing of the calculated current reputation score to the predetermined threshold reputation score. This may have the effect of determining that the first entity has a relatively low reputation score and, in response to the relatively low reputation score, automatically choosing a relatively high number (e.g., at least two) of nearby entities for confirming or investigating the alarm raised by the first entity.

A twenty-sixth embodiment provides a method according to any of the first through twenty-fifth embodiments, wherein:

each reputational record in the plurality of reputational records corresponds to a different entity among the plurality of entities and uniquely identifies the corresponding different entity within the distributed database. This may have the effect of implementing each reputational record as a globally unique identifier for its corresponding entity.

A twenty-seventh embodiment provides a method according to any of the first through twenty-sixth embodiments, wherein:

the distributed database stores a reputation graph that includes the plurality of reputational records, the reputation graph indicating a history of completed events and indicating a corresponding set of participant entities for each completed event in the history of completed events. This may have the effect of enabling the reputational graph to represent an interconnected web of reputational notes that each correspond to the reputational history of a different entity.

A twenty-eighth embodiment provides a method according to any of the first through twenty-seventh embodiments, wherein:

the accessing of the event participation data includes receiving at least a portion of the event participation data from a device that corresponds to an entity among the plurality of entities, the portion indicating actual participation by the entity in the interaction event. This may have the effect of enabling the distributed database to be updated (e.g., by one or more machines aside from the device that sent the event participation data) based on information received from the device that corresponds to the entity (e.g., deliberately sent by a corresponding user entity or autonomously monitored by the device).

A twenty-ninth embodiment provides a method according to any one of the first through twenty-eighth embodiment, wherein:

the accessed event participation data includes a first sentiment indicator that describes the interaction event and is submitted by a first entity among the plurality of entities, the first entity having a first reputation score stored by the distributed database;
the accessed event participation data includes multiple second sentiment indicators that describe the interaction event and are submitted by multiple second entities among the plurality of entities, each of the multiple second entities having a corresponding second reputation score stored by the distributed database;
the first sentiment indicator submitted by the first entity contradicts the second sentiment indicators submitted by the multiple second entities;
the first reputation score of the first entity minus an average of the second reputation scores of the multiple second entities exceeds a standard deviation of the second reputation scores by a predetermined threshold multiplier value; and
in the updating of the distributed database, the extending of each reputational record in the plurality of reputational records includes reducing the first reputation score of the first entity by a first amount that is larger than a second amount by which any of the second reputation scores of the multiple second entities is reduced, the reducing being responsive to the first sentiment indicator contradicting the second sentiment indicators in conjunction with the first reputation score minus the average of the second reputation scores exceeding the standard deviation of the second reputation scores by the predetermined threshold multiplier value. This may have the effect of causing a relatively high reputation score to be more volatile when its corresponding entity provides conflicting feedback about an interaction event compared to multiple (e.g., several) other entities.

A thirtieth embodiment provides a machine-readable medium (e.g., a non-transitory machine-readable storage medium) comprising instructions that, when executed by one or more processors of a machine, cause the machine to perform operations comprising:

receiving an indication that an interaction event with scheduled participation by a plurality of entities has occurred;
accessing a distributed database that stores a plurality of reputational records, each reputational record in the plurality of reputational records encoding a different history of completed events in which participation by a corresponding different entity among the plurality of entities had been scheduled;
accessing event participation data that describes actual participation by the plurality of entities in the interaction event indicated to have occurred; and
updating the distributed database by extending each of the plurality of reputational records that each encodes a different history of completed events in which participation by a corresponding different entity among the plurality of entities had been scheduled, the extending of each reputational record being based on the accessed event participation data and in response to the receiving of the indication that the interaction event has occurred.

A thirty-first embodiment provides a machine-readable medium according to the thirtieth embodiment, wherein the operations further comprise:

accessing a reputational record that corresponds to a location of the interaction event; and
updating the distributed database by extending the reputational record that corresponds to the location of the interaction event based on the event participation data.

A thirty-second embodiment provides a machine-readable medium according to the thirtieth embodiment or the thirty-first embodiment, wherein the operations further comprise:

receiving an entity identifier that identifies a first entity among the plurality of entities, the entity identifier being received from a device of a second entity;
accessing a first extended reputational record from the distributed database based on the entity identifier that identifies the first entity, the first extended reputational record encoding a history of completed events in which participation by the corresponding first entity had been scheduled;
calculating a reputation score of the first entity based on the accessed first extended reputational record that corresponds to the first entity, the calculated reputation score of the first entity quantifying a likelihood that the first entity will successfully participate in future interaction events; and
providing a notification of the calculated reputation score of the first entity to the device of the second entity in response to the receiving of the entity identifier from the device of the second entity.

A thirty-third embodiment provides a system (e.g., a single-computer system or a multi-computer system) comprising:

one or more processors; and
a memory storing instructions that, when executed by at least one processor among the one or more processors, cause the system to perform operations comprising:
receiving an indication that an interaction event with scheduled participation by a plurality of entities has occurred;
accessing a distributed database that stores a plurality of reputational records, each reputational record in the plurality of reputational records encoding a different history of completed events in which participation by a corresponding different entity among the plurality of entities had been scheduled;
accessing event participation data that describes actual participation by the plurality of entities in the interaction event indicated to have occurred; and
updating the distributed database by extending each of the plurality of reputational records that each encodes a different history of completed events in which participation by a corresponding different entity among the plurality of entities had been scheduled, the extending of each reputational record being based on the accessed event participation data and in response to the receiving of the indication that the interaction event has occurred.

A thirty-fourth embodiment provides a system according to the thirty-third embodiment, wherein the operations further comprise:

generating a reputational record that corresponds to the interaction event based on each of the extended reputational records that correspond to the plurality of entities whose actual participation in the interaction event is described by the event participation data; and
updating the distributed database by adding the generated reputational record of the interaction event to the distributed database.

A thirty-fifth embodiment provides a system according to the thirty-third embodiment or the thirty-fourth embodiment, wherein:

the interaction event includes an agreement by a first entity among the plurality of entities to provide reputational support to a second entity among the plurality of entities, the first entity corresponding to a first reputational record among the plurality of reputational records, the second entity corresponding to a second reputational record among the plurality of reputational records;
the event participation data includes agreement data that indicates the first entity is willing to risk entry of negative reputational data into the first reputational record of the first entity in exchange for attribution of positive reputational data to be included in the second reputational record of the second entity; and
the updating of the distributed database includes mapping the first reputational record of the first entity to the second reputational record of the second entity based on the agreement data included in the event participation data.

A thirty-sixth embodiment provides a carrier medium carrying machine-readable instructions for controlling a machine to carry out the method of any one of the first through twenty-ninth embodiments.

What is claimed is:

1. A method comprising:
receiving, by one or more processors of a machine, an indication that an interaction event with scheduled participation by a plurality of entities has occurred;
accessing, by one or more processors of the machine, a distributed database that stores a plurality of reputational records, each reputational record in the plurality of reputational records encoding a different history of completed events in which participation by a corresponding different entity among the plurality of entities had been scheduled;
accessing, by one or more processors of the machine, event participation data that describes actual participation by the plurality of entities in the interaction event indicated to have occurred; and
updating, by one or more processors of the machine, the distributed database by extending each of the plurality of reputational records that each encodes a different history of completed events in which participation by a corresponding different entity among the plurality of entities had been scheduled, the extending of each reputational record being based on the accessed event participation data and in response to the receiving of the indication that the interaction event has occurred.

2. The method of claim 1, wherein:
in the updating of the distributed database, the extending of each reputational record in the plurality of reputational records includes:
generating a hash based on a first portion of the corresponding history of completed events for the reputational record, the generated hash identifying the first portion, the identified first portion encoding a description of a completed event most recently precedent to the interaction event; and
generating a second portion of the corresponding history of completed events and adding the second portion to the corresponding history of completed events, the added second portion encoding a description of the interaction event and including the generated hash that identifies the first portion.

3. The method of claim 1, further comprising:
generating a reputational record that corresponds to the interaction event based on at least a subset of the extended reputational records that correspond to the plurality of entities scheduled to participate in the interaction event, the subset corresponding to entities whose actual participation in the interaction event is described by the event participation data; and
updating the distributed database by adding the generated reputational record of the interaction event to the distributed database.

4. The method of claim 1, further comprising:
accessing a reputational record that corresponds to a location of the interaction event; and
updating the distributed database by extending the reputational record that corresponds to the location of the interaction event based on the event participation data.

5. The method of claim 1, wherein:
the interaction event includes a meeting;
the indication that the interaction event has occurred indicates that the meeting has occurred;
the plurality of entities includes a plurality of persons scheduled to attend the meeting;
the event participation data describes actual attendance by the plurality of persons scheduled to attend the meeting; and
the extending of each reputational record is based on the actual attendance by the plurality of persons and in response to the receiving of the indication that the meeting has occurred.

6. The method of claim 5, further comprising:
generating a reputational record that corresponds to the meeting based on each of the extended reputational records that correspond to the plurality of persons whose actual attendance at the meeting is described by the event participation data; and
updating the distributed database by adding the generated reputational record that corresponds to the meeting to the distributed database.

7. The method of claim 1, wherein:
the interaction event includes a service;
the indication that the interaction event has occurred indicates that the service has been performed;
the plurality of entities includes a plurality of contributors scheduled to perform the service;
the event participation data describes actual contributions by the plurality of contributors to performance of the service; and
the extending of each reputational record is based on the actual contributions by the plurality of contributors and in response to the receiving of the indication that the service has been performed.

8. The method of claim 7, further comprising:
generating a reputational record that corresponds to the performed service based on each of the extended reputational records that correspond to the plurality of contributors whose actual contributions to performance of the service are described by the event participation data; and
updating the distributed database by adding the generated reputational record that corresponds to the performed service to the distributed database.

9. The method of claim 1, wherein:
the interaction event includes assembly of a product;
the indication that the interaction event has occurred indicates that the product has been assembled;
the plurality of entities includes a plurality of components of the product;
the event participation data describes characteristics of the plurality of components; and
the extending of each reputational record is based on the characteristics of the plurality of components and in response to the receiving of the indication that the product has been assembled.

10. The method of claim 9, further comprising:
generating a reputational record that corresponds to the assembled product based on each of the extended reputational records that correspond to the plurality of components whose characteristics are described by the event participation data; and
updating the distributed database by adding the generated reputational record that corresponds to the assembled product to the distributed database.

11. The method of claim 1, wherein:
the interaction event includes preparation of a food;
the indication that the interaction event has occurred indicates that the food has been prepared;
the plurality of entities includes a plurality of ingredients of the food;
the event participation data describes characteristics of the plurality of ingredients; and
the extending of each reputational record is based on the characteristics of the plurality of ingredients and in response to the receiving of the indication that the food has been prepared.

12. The method of claim 11, further comprising:
generating a reputational record that corresponds to the prepared food based on each of the extended reputational records that correspond to the plurality of ingredients whose characteristics are described by the event participation data; and
updating the distributed database by adding the generated reputational record that corresponds to the prepared food to the distributed database.

13. The method of claim 1, further comprising:
receiving an entity identifier that identifies a first entity among the plurality of entities, the entity identifier being received from a device of a second entity;
accessing a first extended reputational record from the distributed database based on the entity identifier that identifies the first entity, the first extended reputational record encoding a history of completed events in which participation by the corresponding first entity had been scheduled;
calculating a reputation score of the first entity based on the accessed first extended reputational record that corresponds to the first entity, the calculated reputation score of the first entity quantifying a likelihood that the first entity will successfully participate in future interaction events; and
providing a notification of the calculated reputation score of the first entity to the device of the second entity in response to the receiving of the entity identifier from the device of the second entity.

14. The method of claim 1, further comprising:
calculating a current reputation score of a first entity among the plurality of entities based on a first extended reputational record that is included in the plurality of extended reputational records and that corresponds to the first entity, the current reputation score of the first entity quantifying a likelihood that the first entity will successfully participate in future interaction events, the current reputation score representing a non-consecutive reduction in the quantified likelihood; and
determining that the first entity is to be excluded from receiving notification of the current reputation score based on the current reputation score representing the non-consecutive reduction in the quantified likelihood.

15. The method of claim 1, further comprising:
calculating a current reputation score of a first entity among the plurality of entities based on a first extended reputational record that is included in the plurality of extended reputational records and that corresponds to the first entity, the current reputation score of the first entity quantifying a likelihood that the first entity will successfully participate in future interaction events, the current reputation score representing a twice-consecutive reduction in the quantified likelihood; and
providing a notification of the calculated current reputation score of the first entity exclusively to a device of the first entity in response to the current reputation score representing the twice-consecutive reduction in the quantified likelihood.

16. The method of claim 1, further comprising:
calculating a current reputation score of a first entity among the plurality of entities based on a first extended reputational record that is included in the plurality of extended reputational records and that corresponds to the first entity, the current reputation score of the first entity quantifying a likelihood that the first entity will successfully participate in future interaction events, the current reputation score representing a thrice-consecutive reduction in the quantified likelihood; and
providing a notification of the calculated current reputation score of the first entity to at least one device of at least one second entity in response to the current reputation score of the first entity representing the thrice-consecutive reduction in the quantified likelihood.

17. The method of claim 1, wherein:
the interaction event includes an agreement by a first entity among the plurality of entities to provide reputational support to a second entity among the plurality of entities, the first entity corresponding to a first reputational record among the plurality of reputational records, the second entity corresponding to a second reputational record among the plurality of reputational records;
the event participation data includes agreement data that indicates the first entity is willing to risk entry of negative reputational data into the first reputational record of the first entity in exchange for attribution of positive reputational data to be included in the second reputational record of the second entity; and
the updating of the distributed database includes mapping the first reputational record of the first entity to the second reputational record of the second entity based on the agreement data included in the event participation data.

18. The method of claim 17, wherein:
in the updating of the distributed database, the extending of each reputational record in the plurality of reputational records includes adding the agreement data to at least one of the first reputational record of the first entity or the second reputational record of the second entity.

19. The method of claim 17, wherein:
in the updating of the distributed database, the extending of each reputational record in the plurality of reputational records includes extending the second reputational record of the second entity by adding the positive reputational data to the second reputational record.

20. The method of claim 17, wherein:
in the updating of the distributed database, the extending of each reputational record in the plurality of reputational records includes extending the second reputational record of the second entity by adding an identifier of the first entity to the second reputational record of the second entity, the added identifier of the first entity attributing the positive reputational data to the first entity.

21. The method of claim 17, further comprising:
adding negative reputational data to the second reputational record of the second entity in response to a further interaction event in which the second entity participated but the first entity did not participate; and
adding at least a portion of the negative reputational data to the first reputational record of the first entity based on the agreement data that indicates the first entity is willing to risk entry of negative reputational data into the first reputational record of the first entity in exchange for attribution of the positive reputational data.

22. The method of claim 17, further comprising:
adding further positive reputational data to the second reputational record of the second entity in response to a further interaction event in which the second entity participated but the first entity did not participate; and
adding at least a portion of the further positive reputational data to the first reputational record of the first entity based on the mapping of the first reputational record of the first entity to the second reputational record of the second entity.

23. The method of claim 1, further comprising:
detecting an alarm issued by a first device that corresponds to a first identifier of a first entity among the plurality of entities;
accessing a first extended reputational record from the distributed database based on the first identifier of the first entity, the first extended reputational record encoding a history of completed events in which participation by the corresponding first entity had been scheduled;
detecting that a set of second devices that correspond to second entities represented by the distributed database is within a predetermined threshold geographical distance of the first device that issued the detected alarm;
selecting a subset of the detected set of second devices based on the first extended reputational record that corresponds to the first entity; and
communicating a request to each second device in the subset selected from the detected set of second devices, the communicated request asking each corresponding second entity to verify the alarm issued by the first device that corresponds to the first entity.

24. The method of claim 23, further comprising:
calculating a current reputation score of the first entity based on the first extended reputational record accessed from the distributed database; and
comparing the calculated current reputation score of the first entity to a predetermined threshold reputation score; and wherein
the selecting of the subset of the detected set of second devices selects a single second device among the detected set of second devices based on the comparing of the calculated current reputation score to the predetermined threshold reputation score.

25. The method of claim 23, further comprising:
calculating a current reputation score of the first entity based on the first extended reputational record accessed from the distributed database; and
comparing the calculated current reputation score of the first entity to a predetermined threshold reputation score; and wherein
the selecting of the subset of the detected set of second devices selects a plurality of second devices among the detected set of second devices based on the comparing of the calculated current reputation score to the predetermined threshold reputation score.

26. The method of claim 1, wherein:
each reputational record in the plurality of reputational records corresponds to a different entity among the plurality of entities and uniquely identifies the corresponding different entity within the distributed database.

27. The method of claim 1, wherein:
the distributed database stores a reputation graph that includes the plurality of reputational records, the reputation graph indicating a history of completed events and indicating a corresponding set of participant entities for each completed event in the history of completed events.

28. The method of claim 1, wherein:
the accessing of the event participation data includes receiving at least a portion of the event participation data from a device that corresponds to an entity among the plurality of entities, the portion indicating actual participation by the entity in the interaction event.

29. The method of claim 1, wherein:
the accessed event participation data includes a first sentiment indicator that describes the interaction event and is submitted by a first entity among the plurality of entities, the first entity having a first reputation score stored by the distributed database;
the accessed event participation data includes multiple second sentiment indicators that describe the interaction event and are submitted by multiple second entities among the plurality of entities, each of the multiple second entities having a corresponding second reputation score stored by the distributed database;
the first sentiment indicator submitted by the first entity contradicts the second sentiment indicators submitted by the multiple second entities;
the first reputation score of the first entity minus an average of the second reputation scores of the multiple second entities exceeds a standard deviation of the second reputation scores by a predetermined threshold multiplier value; and
in the updating of the distributed database, the extending of each reputational record in the plurality of reputational records includes reducing the first reputation score of the first entity by a first amount that is larger than a second amount by which any of the second reputation scores of the multiple second entities is reduced, the reducing being responsive to the first sentiment indicator contradicting the second sentiment indicators in conjunction with the first reputation score minus the average of the second reputation scores exceeding the standard deviation of the second reputation scores by the predetermined threshold multiplier value.

30. A non-transitory machine-readable storage medium comprising instructions that, when executed by one or more processors of a machine, cause the machine to perform operations comprising:
receiving an indication that an interaction event with scheduled participation by a plurality of entities has occurred;
accessing a distributed database that stores a plurality of reputational records, each reputational record in the plurality of reputational records encoding a different history of completed events in which participation by a corresponding different entity among the plurality of entities had been scheduled;
accessing event participation data that describes actual participation by the plurality of entities in the interaction event indicated to have occurred; and
updating the distributed database by extending each of the plurality of reputational records that each encodes a different history of completed events in which participation by a corresponding different entity among the plurality of entities had been scheduled, the extending of each reputational record being based on the accessed event participation data and in response to the receiving of the indication that the interaction event has occurred.

31. The non-transitory machine-readable storage medium of claim 30, wherein the operations further comprise:
accessing a reputational record that corresponds to a location of the interaction event; and
updating the distributed database by extending the reputational record that corresponds to the location of the interaction event based on the event participation data.

32. The non-transitory machine-readable storage medium of claim 30, wherein the operations further comprise:
receiving an entity identifier that identifies a first entity among the plurality of entities, the entity identifier being received from a device of a second entity;
accessing a first extended reputational record from the distributed database based on the entity identifier that identifies the first entity, the first extended reputational record encoding a history of completed events in which participation by the corresponding first entity had been scheduled;
calculating a reputation score of the first entity based on the accessed first extended reputational record that corresponds to the first entity, the calculated reputation score of the first entity quantifying a likelihood that the first entity will successfully participate in future interaction events; and
providing a notification of the calculated reputation score of the first entity to the device of the second entity in response to the receiving of the entity identifier from the device of the second entity.

33. A system comprising:
one or more processors; and
a memory storing instructions that, when executed by at least one processor among the one or more processors, cause the system to perform operations comprising:
receiving an indication that an interaction event with scheduled participation by a plurality of entities has occurred;
accessing a distributed database that stores a plurality of reputational records, each reputational record in the plurality of reputational records encoding a different history of completed events in which participation by a corresponding different entity among the plurality of entities had been scheduled;
accessing event participation data that describes actual participation by the plurality of entities in the interaction event indicated to have occurred; and
updating the distributed database by extending each of the plurality of reputational records that each encodes a different history of completed events in which participation by a corresponding different entity among the plurality of entities had been scheduled, the extending of each reputational record being based on the accessed event participation data and in response to the receiving of the indication that the interaction event has occurred.

34. The system of claim 33, wherein the operations further comprise:
generating a reputational record that corresponds to the interaction event based on at least a subset of the extended reputational records that correspond to the plurality of entities scheduled to participate in the interaction event, the subset corresponding to entities whose actual participation in the interaction event is described by the event participation data; and
updating the distributed database by adding the generated reputational record of the interaction event to the distributed database.

35. The system of claim 33, wherein:
the interaction event includes an agreement by a first entity among the plurality of entities to provide reputational support to a second entity among the plurality of entities, the first entity corresponding to a first reputational record among the plurality of reputational records, the second entity corresponding to a second reputational record among the plurality of reputational records;
the event participation data includes agreement data that indicates the first entity is willing to risk entry of negative reputational data into the first reputational record of the first entity in exchange for attribution of positive reputational data to be included in the second reputational record of the second entity; and
the updating of the distributed database includes mapping the first reputational record of the first entity to the second reputational record of the second entity based on the agreement data included in the event participation data.
